(19) United States
(12) Patent Application Publication
(10) Pub. No.: US 2003/0039881 A1
(43) Pub. Date: Feb. 27, 2003

(54) Battery accessible modules for rack mount systems

(76) Inventor: Robert L. Mount, Lindon, UT (US)

Correspondence Address: Everett D. Robinson, Parsons Behle & Latimer, 333 South 520 West, Suite 220, Lindon, UT, 84042, US

(21) Appl. No.: 10/225,019

(22) Filed: Aug. 21, 2002

Related U.S. Application Data
(60) Provisional application No. 60/314,084, filed on Aug. 22, 2001.

(51) Int. Cl. H01M 2/10

(52) U.S. Cl. 429/100; 429/99

(57) ABSTRACT

The inventions relate generally to uninterruptible power supply enclosures and rack-mountable battery enclosures. More particularly, the inventions relate to inverter and battery enclosures that are rack-mountable and provide access to the internal batteries in mounted positions. Disclosed herein are cabinet structures which facilitate the replacement of batteries in rack-mount devices using repositionable front covers and internal battery mounting systems whereby batteries may be installed and removed through an aperture that may be exposed through the front cover. Detailed information on various example embodiments of the inventions are provided in the Detailed Description below, and the inventions are defined by the appended claims.

### CROSS-REFERENCE TO RELATED APPLICATIONS

This application claims the benefit of U.S. Provisional Application No. 60/314,084 filed Aug. 22, 2001.

### BACKGROUND OF THE INVENTIONS

Electronic devices such as computer systems and uninterruptable power supply systems can be mounted in an electronics rack, saving floor space, providing organization, and protecting cables to the rack mounted components. Common rack mountable cabinets include four vertical rails into which are fashioned a series of regular holes, into which screws or other positioning devices may be inserted to maintain electronic equipment in a fixed position. The regular holes define a series of regular positions into which inserted components may be secured. The heights of the components conforming to a standard are typically sized in mounting unit increments to allow for the efficient utilization of rack space and the standardization of rack structures. An example of a definable mounting increment is a RETMA (U) unit for an electronics rack conforming to the commonly used EIA-310 standard.

Rack mountable UPS systems may be fashioned with an interior battery, provided that the battery is not too large for the enclosure. Those systems can provide a limited amount of power to electrical equipment in the event of power loss. Other UPS systems provide battery modules in a separate cabinet from the inverter cabinet. Those systems can provide more power than the UPS systems with internal batteries. Some UPS systems also permit the combination of a single inverter with multiple battery modules, providing even more emergency power. Most commonly in UPS systems batteries of the lead-acid type are included, as they are currently the most economical in terms of cost per amount of energy stored.

Through the course of operation of a UPS device, batteries eventually fail. This is especially true of lead-acid batteries, which can be expected to have lifespans of about three to seven years under favorable circumstances. One factor which accelerates battery failure is overcharging. Most charging circuits do not intelligently monitor the charge state of the batteries; rather to save cost simplified circuits are used which are based on providing a constant current to the battery. In some circuits a two step approach is used. First, when a battery is detected to have been discharged, a large current is provided to a battery to provide a quick recharge. The second step is to provide a trickle-charge to the battery to maintain the charge in the full state. This trickle-charge, although small, will contribute to the failure of the battery. Further accelerating lead-acid battery failure are discharge and recharge events, especially if batteries become nearly exhausted of charge. In UPS systems this event may be repeated each time a power loss occurs.

Because of the limited lifetime of the batteries, manufacturers often recommend replacement of the batteries after a number of years of use. In the past, replacement of a battery entails powering down systems relying on the UPS, removing the UPS from those systems, removing a cover, replacing the battery, reinstalling the cover and UPS, and powering up the dependent systems. For rack-mountable UPS systems, additional steps of unmounting and remounting the UPS in the rack are also generally required. These additional steps also generally mandate the requirement of powering down the UPS systems and dependent equipment, as cables reaching from the equipment in the rack and the cabinet containing the battery are generally not long enough to permit the cabinet to be set on a nearby bench during the procedure. Additionally cables may be entangled or may become dislodged, and thus the dependent equipment is subject to accidental power loss should the power be left active during the battery replacement procedure. Because of this, battery replacement has in the past been a cumbersome procedure.

Thus there is a need for rack-mountable enclosures suitable for containing a battery, providing access to the battery without removal of the enclosure from the rack, potentially permitting replacement of a battery without requiring a power down of a UPS or dependent equipment.

### BRIEF SUMMARY OF THE INVENTIONS

The inventions relate generally to uninterruptible power supply enclosures and rack-mountable battery enclosures. More particularly, the inventions relate to inverter and battery enclosures that are rack-mountable and provide access to the internal batteries in mounted positions.

Disclosed herein are cabinet structures which facilitate the replacement of batteries in rack-mount devices using repositionable front covers and internal battery mounting systems whereby batteries may be installed and removed through an aperture that may be exposed through the front cover. Detailed information on various example embodiments of the inventions are provided in the Detailed Description below, and the inventions are defined by the appended claims.

### BRIEF DESCRIPTION OF THE DRAWINGS

FIG. 1 shows an exploded view of a rack-mountable battery module providing front panel access to two battery sleds.

FIG. 2 shows an exploded view of a rack-mountable inverter cabinet.

FIG. 3 shows an exploded view of an inverter cabinet capable of housing an internal battery accessible through a repositionable front panel.

FIG. 4 illustrates a battery module in a rack-mountable configuration.

FIG. 5 illustrates an example battery module in a floor mount configuration.

FIG. 6 illustrates an inverter product in a rack-mountable configuration, wherein an inverter is contained.

FIG. 7 illustrates an inverter product in a floor mount configuration.

FIG. 8 illustrates an inverter product in a rack-mountable configuration.

FIG. 9 illustrates an inverter product in a floor mount configuration.

FIG. 10 shows a top view of an example bezel that may be included in a cabinet assembly.

FIG. 11 shows a front view of an example bezel that may be included in a cabinet assembly.

FIG. 12 shows a bottom view of an example bezel that may be included in a cabinet assembly.

FIG. 13 shows a left side view of an example bezel that may be included in a cabinet assembly.

FIG. 14 shows a right side view of an example bezel that may be included in a cabinet assembly.

FIG. 15 shows a perspective view of an example bezel that may be included in a cabinet assembly.

FIG. 16 shows a top view of an example insert that may be included in a battery module cabinet assembly.

FIG. 17 shows a front view of an example insert that may be included in a battery module cabinet assembly.

FIG. 18 shows a right side view of an example insert that may be included in a battery module cabinet assembly.

FIG. 19 shows a top view of an example filter bracket.

FIG. 20 shows a front view of an example filter bracket.

FIG. 21 shows a bottom view of an example filter bracket.

FIG. 22 shows a right side view of an example filter bracket.

FIG. 23 shows a top view of an example insert that may be included in an inverter product cabinet assembly.

FIG. 24 shows a front view of an example insert that may be included in an inverter product cabinet assembly.

FIG. 25 shows a right side view of an example insert that may be included in an inverter product cabinet assembly.

FIG. 26 shows a top view of an example filter bracket that may be combined with the insert of FIGS. 23, 24 and 25.

FIG. 27 shows a front view of an example filter bracket that may be combined with the insert of FIGS. 23, 24 and 25.

FIG. 28 shows a bottom view of an example filter bracket that may be combined with the insert of FIGS. 23, 24 and 25.

FIG. 29 shows a right side view of an example filter bracket that may be combined with the insert of FIGS. 23, 24 and 25.

FIG. 30 shows a top view of an example base for a battery module capable of holding two battery sleds in rails in the interior of the battery module cabinet.

FIG. 31 shows a left side view of an example base for a battery module capable of holding two battery sleds in rails in the interior of the battery module cabinet.

FIG. 32 shows a front view of an example base for a battery module capable of holding two battery sleds in rails in the interior of the battery module cabinet.

FIG. 33 shows a bottom view of an example base for a battery module capable of holding two battery sleds in rails in the interior of the battery module cabinet.

FIG. 34 shows a right side view of an example base for a battery module capable of holding two battery sleds in rails in the interior of the battery module cabinet.

FIG. 35 shows a perspective view of an example base for a battery module capable of holding two battery sleds in rails in the interior of the battery module cabinet.

FIG. 36 shows a top view of an example base for an inverter product capable of holding a single battery sled in rails in the interior of the inverter product cabinet.

FIG. 37 shows a left side view of an example base for an inverter product capable of holding a single battery sled in rails in the interior of the inverter product cabinet.

FIG. 38 shows a front view of an example base for an inverter product capable of holding a single battery sled in rails in the interior of the inverter product cabinet.

FIG. 39 shows a bottom view of an example base for an inverter product capable of holding a single battery sled in rails in the interior of the inverter product cabinet.

FIG. 40 shows a right side view of an example base for an inverter product capable of holding a single battery sled in rails in the interior of the inverter product cabinet.

FIG. 41 shows a perspective view of an example base for an inverter product capable of holding a single battery sled in rails in the interior of the inverter product cabinet.

FIG. 42 shows a top view of an example base for a battery module cabinet capable of receiving rack mounts or swing-leg mounts as described above.

FIG. 43 shows a left side view of an example base for a battery module cabinet capable of receiving rack mounts or swing-leg mounts as described above.

FIG. 44 shows a front view of an example base for a battery module cabinet capable of receiving rack mounts or swing-leg mounts as described above.

FIG. 45 shows a bottom view of an example base for a battery module cabinet capable of receiving rack mounts or swing-leg mounts as described above.

FIG. 46 shows a right side view of an example base for a battery module cabinet capable of receiving rack mounts or swing-leg mounts as described above.

FIG. 47 shows a perspective view of an example base for a battery module cabinet capable of receiving rack mounts or swing-leg mounts as described above.

FIG. 48 shows a top view of an example left side bracket that may be included in one of the illustrated inverter product cabinets.

FIG. 49 shows a front view of an example left side bracket that may be included in one of the illustrated inverter product cabinets.

FIG. 50 shows a perspective view of an example right side bracket that may be included in a battery module or inverter product cabinet.

FIG. 51 shows a left side view of an example right side bracket that may be included in a battery module or inverter product cabinet.

FIG. 52 shows a perspective view of an example left side bracket that may be included in one of the illustrated inverter product cabinets.

FIG. 53 shows a right side view of an example left side bracket that may be included in one of the illustrated inverter product cabinets.

FIG. 54 shows a top view of an example right side bracket that may be included in a battery module or inverter product cabinet.

FIG. 55 shows a front view of an example right side bracket that may be included in a battery module or inverter product cabinet.

FIG. 56 shows a top side view of another example left side bracket that may be included in one of the illustrated battery module products.

FIG. 57 shows a front side view of another example left side bracket that may be included in one of the illustrated battery module products.

FIG. 58 shows a perspective view of another example left side bracket that may be included in one of the illustrated battery module products.

FIG. 59 shows a right side view of another example left side bracket that may be included in one of the illustrated battery module products.

FIG. 60 shows a rear view of an example removable sled base providing alignment.

FIG. 61 shows a left side view of an example removable sled base providing alignment.

FIG. 62 shows a front side view of an example removable sled base providing alignment.

FIG. 63 shows a perspective view of an example removable sled base providing alignment.

FIG. 64 shows a top view of an example removable sled base providing alignment.

FIG. 65 shows a right side view of an example removable sled base providing alignment.

FIG. 66 shows a top view of a sled top cover that may be combined with the sled base of FIGS. 60, 61, 62, 63, 64 and 65 to contain one or more batteries.

FIG. 67 shows a perspective view of a sled top cover that may be combined with the sled base of FIGS. 60, 61, 62, 63, 64 and 65 to contain one or more batteries.

FIG. 68 shows a left side view of a sled top cover that may be combined with the sled base of FIGS. 60, 61, 62, 63, 64 and 65 to contain one or more batteries.

FIG. 69 shows a front view of a sled top cover that may be combined with the sled base of FIGS. 60, 61, 62, 63, 64 and 65 to contain one or more batteries.

FIG. 70 shows a right side view of a sled top cover that may be combined with the sled base of FIGS. 60, 61, 62, 63, 64 and 65 to contain one or more batteries.

FIG. 71 shows a top view of an example rear panel of an inverter product.

FIG. 72 shows a left side view of an example rear panel of an inverter product.

FIG. 73 shows a front view of an example rear panel of an inverter product.

FIG. 74 shows a right side view of an example rear panel of an inverter product.

FIG. 75 shows a bottom view of an example rear panel of an inverter product.

FIG. 76 illustrates a filler panel for a rear panel having a fitting for an ethernet panel.

FIG. 77 shows a top view of an example rear panel of a battery module.

FIG. 78 shows a left side view of an example rear panel of a battery module.

FIG. 79 shows a front view of an example rear panel of a battery module.

FIG. 80 shows a right side view of an example rear panel of a battery module.

FIG. 81 shows a bottom view of an example rear panel of a battery module.

FIG. 82 shows a top view of an example rear panel of an inverter product.

FIG. 83 shows a left side view of an example rear panel of an inverter product.

FIG. 84 shows a front view of an example rear panel of an inverter product.

FIG. 85 shows a bottom view of an example rear panel of an inverter product.

FIG. 86 shows a perspective view of an example rear panel of an inverter product.

FIG. 87 shows a right side view of an example rear panel of an inverter product.

FIG. 88 shows a top view of an example top cover suitable for illustrated examples of battery modules and inverter products.

FIG. 89 shows a left side view of an example top cover suitable for illustrated examples of battery modules and inverter products.

FIG. 90 shows a front view of an example top cover suitable for illustrated examples of battery modules and inverter products.

FIG. 91 shows a bottom view of an example top cover suitable for illustrated examples of battery modules and inverter products.

FIG. 92 shows a right side view of an example top cover suitable for illustrated examples of battery modules and inverter products.

FIG. 93 shows a perspective view of an example top cover suitable for illustrated examples of battery modules and inverter products.

FIG. 94 shows a top view of an example breaker bracket of a battery module capable of receiving a circuit breaker.

FIG. 95 shows a front view of an example breaker bracket of a battery module capable of receiving a circuit breaker.

FIG. 96 shows a right side view of an example breaker bracket of a battery module capable of receiving a circuit breaker.

FIG. 97 shows the front side of a breaker panel that may be combined with a breaker bracket of the illustrated examples of the invention.

FIG. 98 shows a top view of another example breaker bracket capable of receiving a circuit breaker.

FIG. 99 shows a front view of another example breaker bracket capable of receiving a circuit breaker.

FIG. 100 shows a right side view of another example breaker bracket capable of receiving a circuit breaker.

FIG. 101 shows a front side view of another example breaker panel that may be combined with a breaker bracket of illustrated examples of the invention.

FIG. 102 shows a lower leg bracket capable of receiving swing legs and mountable to a cabinet.

FIG. 103 shows an alternate lower leg bracket.

FIG. 104 depicts a top key for securing adjacent cabinets utilizing a swing leg stand.

FIG. 105 shows a swing leg of the illustrated cabinet mounting examples.

FIG. 106 shows a top view of an example rack mount bracket for mounting a cabinet to a rack.

FIG. 107 shows a perspective view of an example rack mount bracket for mounting a cabinet to a rack.

FIG. 108 shows a front view of an example rack mount bracket for mounting a cabinet to a rack.

FIG. 109 shows a right side view of an example rack mount bracket for mounting a cabinet to a rack.

FIG. 110 shows a top view of an example ethernet bracket of the illustrated products.

FIG. 111 shows a left side view of an example ethernet bracket of the illustrated products.

FIG. 112 shows a front view of an example ethernet bracket of the illustrated products.

FIG. 113 shows a bottom view of an example ethernet bracket of the illustrated products.

FIG. 114 shows a perspective view of an example ethernet bracket of the illustrated products.

FIG. 115 shows a right side view of an example ethernet bracket of the illustrated products.

FIG. 116 depicts one outlet panel that may receive outlets and is mountable to some inverter products.

FIG. 117 depicts an alternate outlet panel used on other inverter products.

FIG. 118 shows a top view of an example face plate that may be used in illustrated examples of inverter products.

FIG. 119 shows a perspective view of an example face plate that may be used in illustrated examples of inverter products.

FIG. 120 shows a front side view of an example face plate that may be used in illustrated examples of inverter products.

FIG. 121 shows a right side view of an example face plate that may be used in illustrated examples of inverter products.

FIG. 122 shows a top view of an example left wire channel of illustrated products.

FIG. 123 shows a left side view of an example left wire channel of illustrated products.

FIG. 124 shows a front view of an example left wire channel of illustrated products.

FIG. 125 shows a right side view of an example left wire channel of illustrated products.

FIG. 126 shows a bottom view of an example left wire channel of illustrated products.

FIG. 127 shows a front side view of a connector top bracket that may be used to house connectors.

FIG. 128 shows a right side view of a connector top bracket that may be used to house connectors.

FIG. 129 shows a bottom view of a connector top bracket that may be used to house connectors.

FIG. 130 shows a perspective view of a connector top bracket that may be used to house connectors.

FIG. 131 shows a perspective view of a sled rail that may be used in illustrated products.

FIG. 132 shows a front side view of a sled rail that may be used in illustrated products.

FIG. 133 shows a right side view of a sled rail that may be used in illustrated products.

FIG. 134 shows a top view of an example sled stop bracket.

FIG. 135 shows a perspective view of an example sled stop bracket.

FIG. 136 shows a front view of an example sled stop bracket.

FIG. 137 shows a right side view of an example sled stop bracket.

FIG. 138 shows a top view of a connector bottom bracket that may be combined with the connector top bracket of FIGS. 127, 128, 129 and 130.

FIG. 139 shows a perspective view of a connector bottom bracket that may be combined with the connector top bracket of FIGS. 127, 128, 129 and 130.

FIG. 140 shows a front side view of a connector bottom bracket that may be combined with the connector top bracket of FIGS. 127, 128, 129 and 130.

FIG. 141 shows a right side view of a connector bottom bracket that may be combined with the connector top bracket of FIGS. 127, 128, 129 and 130.

FIG. 142 shows a top view of a center wire channel of illustrated products.

FIG. 143 shows a front view of a center wire channel of illustrated products.

FIG. 144 shows a right side view of a center wire channel of illustrated products.

FIG. 145 shows a top view of an example right wire channel.

FIG. 146 shows a left side view of an example right wire channel.

FIG. 147 shows a front view of an example right wire channel.

FIG. 148 shows a right side view of an example right wire channel.

FIG. 150 shows a top view of a sled handle bracket that may be attached to a battery sled.

FIG. 151 shows a left side view of a sled handle bracket that may be attached to a battery sled.

FIG. 152 shows a perspective view of a sled handle bracket that may be attached to a battery sled.

FIG. 153 shows a front view of a sled handle bracket that may be attached to a battery sled.

FIG. 154 shows a bottom view of a sled handle bracket that may be attached to a battery sled.

FIG. 155 shows a top view of an example sled alignment bracket of the illustrated products.

FIG. 156 shows a front view of an example sled alignment bracket of the illustrated products.

FIG. 157 shows a right side view of an example sled alignment bracket of the illustrated products.

FIG. 158 shows a top view of an alternate sled rail with improved ease of alignment.

FIG. 159 shows a front view of an alternate sled rail with improved ease of alignment.

FIG. 160 shows a right side view of an alternate sled rail with improved ease of alignment.

FIG. 161 illustrates a battery protection system of the invention.

FIG. 162 illustrates a battery protection procedure.

Reference will now be made in detail to some embodiments of the inventions, example of which are illustrated in the accompanying drawings.

### DETAILED DESCRIPTION

In the illustrated examples components may be fashioned from sheet metal through stamping and bending process, or other processes known to those skilled in the art. Other components may be fashioned through the use of plastic injection molding techniques.

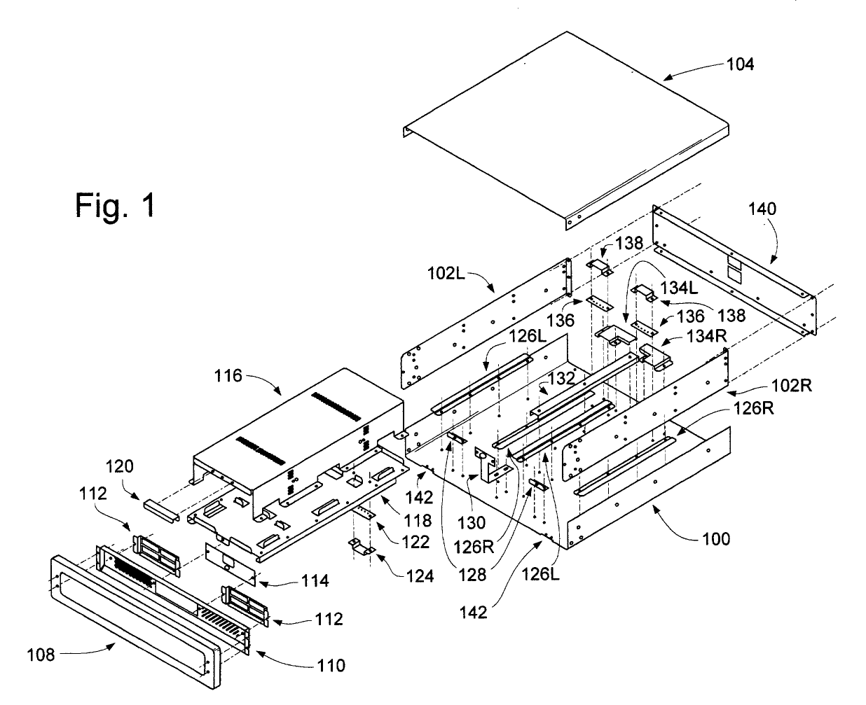

FIG. 1 shows an exploded view of a rack-mountable battery module providing front panel access to two battery sleds. A base 100, right side bracket 102R, left side bracket 102L, top cover 104, and rear panel 140 form a cabinet to which other components may be enclosed and attached. Sled rails 126L and 126R provide guidance for the movement of sled bases 118 within the battery module. Sled stop brackets 128 are provided to stop the movement of sled bases 118 in a nominal position within the battery module, and may also provide for fastening a sled base 118 to the brackets 128 to secure the battery sled to the battery module. Sled top covers 116 attach to sled bases 118, forming a battery enclosure whereby a battery may be contained and protected. A connector top bracket 124 and a connector bottom bracket 122 provide mounting for one or more electrical connectors. In a preferred embodiment the connector top and bottom brackets are designed to contain 30A Powerpole® connectors made by Anderson Power Products of Sterling, Mass. Brackets 122 and 124 attach to sled base 118 to maintain the attached connectors in a fixed position relative to the sled base. A sled handle 120 may be provided to ease handling of the battery enclosure. Attached to base 100 are brackets 136 and 138 which likewise provide mounting for electrical connectors. Brackets 136 and 138 are mounted in a position relative to base 100 such that insertion of sled base 118 into rails 126L and 126R in a final position permits the electrical connectors to mate. Wire guides 134R and 134L may be included to restrain wires to connectors mounted by brackets 136 and 138. A breaker bracket 130 may be included to provide mounting to a circuit breaker, or other electrical hardware, relative to base 100. Hinge mounts 142 provide mounting for hinges by which a front cover may be attached. In this illustration a front cover is formed by a bezel 108 and an insert 110. Filter brackets 112 provide mounting of dust filters to insert 110. A panel 114 is also mounted to insert 110, which may provide mounting for indicators or controls, and may also have apertures through which devices mounted to breaker bracket 130 may be viewed and controlled. A center wire channel 132 provides restriction and organization of internal wires.

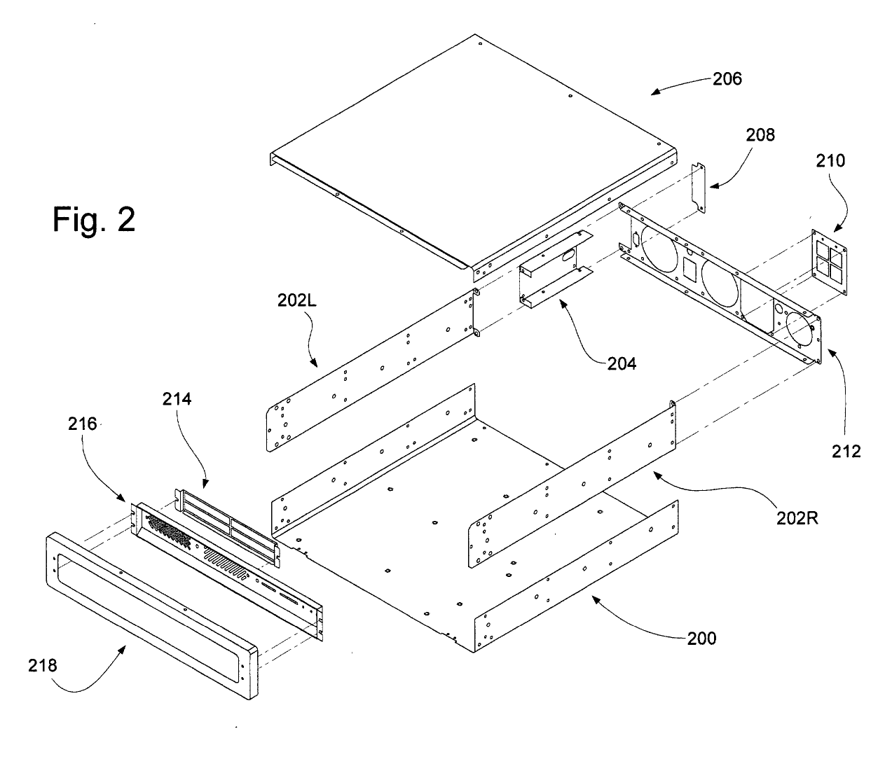

FIG. 2 shows an exploded view of a rack-mountable inverter cabinet according to the invention. A cabinet is formed by a base 200, a right side bracket 202R, a left side bracket 202L, a top cover 206, and a rear panel 212. A front cover is formed by a bezel 218, an insert 216, and a filter bracket 214. The front cover is mounted to base 200 through hinges as in the module of FIG. 1. An outlet panel 210 provides mounting for outlets powered by the inverter. An ethernet bracket 204 may be provided to house a controller and ethernet electronics to provide network functions to client network devices. A filler panel 208 may be installed if ethernet functionality is not desired. Otherwise an ethernet face plate, such as shown in FIGS. 118, 119, 120 and 121 may be installed in the same location.

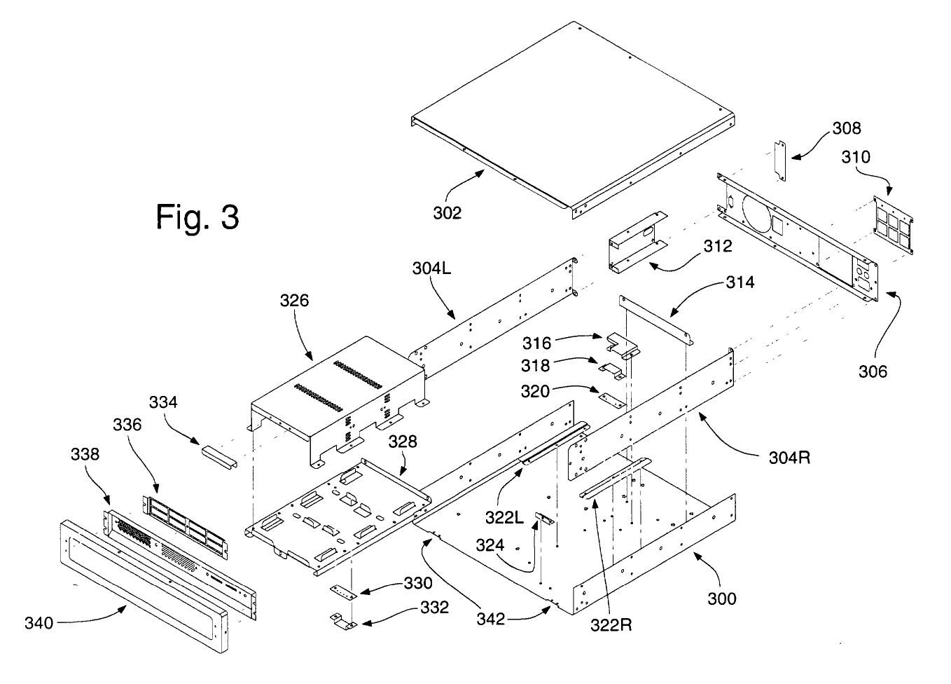

FIG. 3 shows an exploded view of an inverter cabinet capable of housing an internal battery accessible through a repositionable front panel. A cabinet is formed by a base 300, a right side bracket 304R, a left side bracket 304L, a top cover 302 and a rear panel 306. Sled rails 322L and 322R provide guidance for the movement of sled bases 328 within the inverter cabinet. A sled stop bracket 324 provides a stop for sled bases 328 to a normal position relative to base 300, and may also provide for fastening a sled base 328 to a brackets 324 to secure the battery sled to the inverter cabinet. Sled top covers 326 attach to sled bases 328, forming a battery enclosure whereby a battery may be contained and protected. A connector top bracket 332 and a connector bottom bracket 330 provide mounting for one or more electrical connectors. Brackets 330 and 332 attach to sled base 328 to maintain the attached connectors in a fixed position relative to the sled base. A sled handle 334 may be provided. Attached to base 300 are brackets 318 and 320 which provide mounting for mating electrical connectors, these connectors mating with the connectors mounted by brackets 330 and 332. Brackets 318 and 320 are mounted in a position relative to base 300 such that insertion of sled base 328 into rails 322L and 322R in a final position permits the electrical connectors to mate. A wire guide 316 may be included to restrain wires to connectors mounted by brackets 318 and 320. A sled alignment bracket 314 may be provided to further position a sled base 328 relative to base 300. Hinge mounts 342 provide mounting for hinges by which a front cover may be attached. In this illustration a front cover is formed by a bezel 340 and an insert 338. A filter bracket 336 provides mounting of a dust filter. An outlet panel 310 provides mountings for outlets powered by the inverter of the cabinet. An ethernet bracket 312 may be provided to house a controller and ethernet electronics to provide network functions to client network devices. A filter panel 308 may be installed in ethernet functionality is not provided. Otherwise an ethernet face plate, such as shown in FIGS. 118, 119, 120, and 121 may be installed in the same location.

In the examples of FIGS. 1, 2, and 3, access to the batteries is provided through the front cover by the removal of two screws, after which the front cover may be swung down. Other systems and methods of relocation of a front cover are within the inventive concepts: for example a sliding front cover, a removable cover secured with thumbscrews or other connectors, covers hinging from the sides or the top, and covers with doors and apertures. Also in the examples of FIGS. 1, 2, and 3 are systems for securing a battery inside an enclosure using rails, all through an aperture in the front of the enclosure. In those examples alignment features are also provided to align an electrical connector and a battery enclosure to the mounts. Other systems and methods of securing batteries are within the inventive concepts, for example spring clips and guide rods. Other alignment features are also considered to be within the scope of the invention, for example keyed brackets and tapered guides.

In preferred systems of the invention a battery may be removed from a battery module or inverter product without powering the equipment down. Access to filters for replacement and cleaning is also provided in those systems through repositioning of the front cover. Additionally in the preferred systems the connection and disconnection of the battery and the battery module is effected by inserting a battery sled into a battery module or inverter product, without additional manual steps.

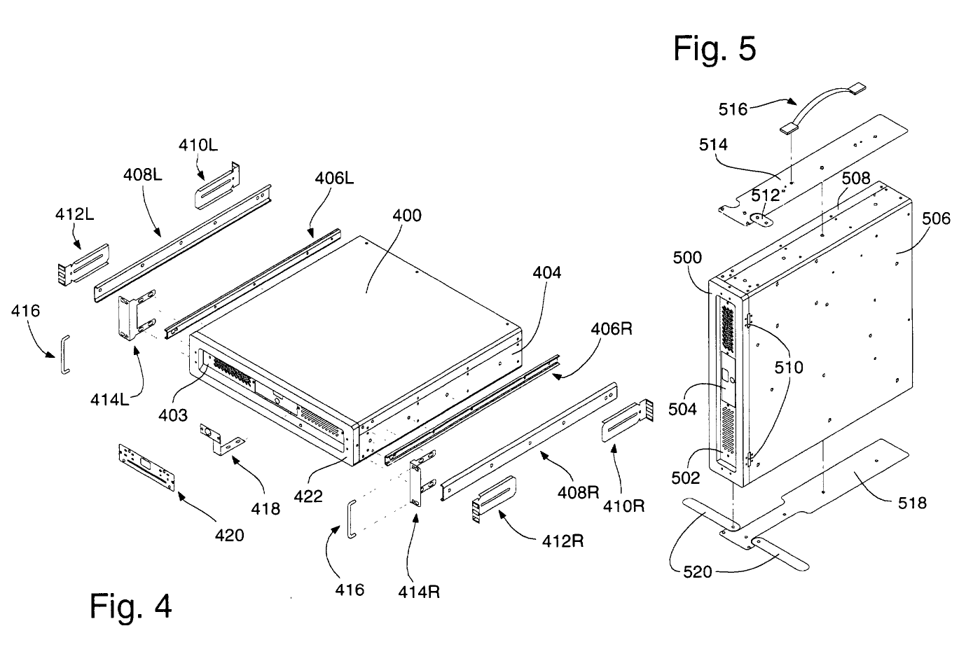

FIG. 4 illustrates a battery module in a rack-mountable configuration. A battery module cabinet includes a top cover 400, a base 404, a bezel 402, and an insert 403. Inner slide rails 406R and 406L are fastened to base 404. Outer slide rails 408L and 408R are positionable to slide relative to inner slide rails 406R and 406L. Front mounting brackets 412R and 412L and rear mounting brackets 410R and 410L fasten to outer slide rails 408R and 408L and are securable to a rack cabinet. Rack mount brackets 414R and 414L fasten to the battery module cabinet providing additional fastening points to secure the module to a rack, fixing the module in the direction of the slide rail movement. Handles 416 may also be provided.

FIG. 5 illustrates an example battery module in a floor mount configuration. A battery module cabinet includes a top cover 508, a base 506, a bezel 500, an insert 502, and a panel 504. In this example hinges 510 provide connection from bezel 500 to base 506 and permit access to the interior of the battery module cabinet by repositioning the front panel of components 500, 502, and 504. Two opposing swing legs 520 are attached to a lower leg bracket 518, which is in turn affixed to one side of base 506. On the opposing side of the module cabinet a handle bracket 514 is attached, to which a handle 516 is attached to permit ease of carrying the battery module. A key 512 may also be attached to adjoining cabinets to increase the stability of the set of cabinets.

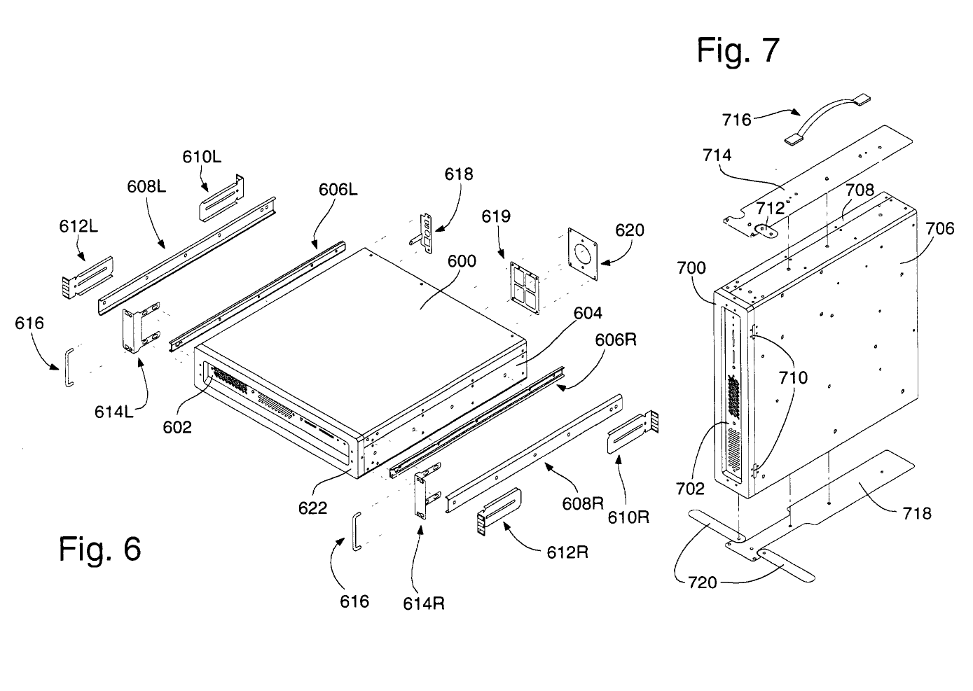

FIG. 6 illustrates an inverter product in a rack-mountable configuration, wherein an inverter is contained. An inverter product cabinet includes a top cover 600, a base 604, a bezel 622, and an insert 602. Inner slide rails 606R and 606L are fastened to base 604. Outer slide rails 608L and 608R are positionable to slide relative to inner slide rails 606R and 606L. Front mounting brackets 612R and 612L and rear mounting brackets 610R and 610L fasten to outer slide rails 608R and 608L and are securable to a rack cabinet. Rack mount brackets 614R and 614L fasten to the inverter product cabinet providing additional fastening points to secure the inverter product to a rack, fixing the module in the direction of the slide rail movement. Handles 616 may also be provided. Also shown are ethernet face plate 618, and two types of outlet panels 619 and 620, which may be included in inverter product of this example.

FIG. 7 illustrates an inverter product in a floor mount configuration, the inverter product containing inverter electronics. An inverter product cabinet includes a top cover 708, a base 706, a bezel 700, and an insert 702. In this example hinges 710 provide connection from bezel 700 to base 706 and permit access to he interior of the inverter product cabinet by repositioning the front panel of components 700 and 702. Two opposing swing legs 720 are attached to a lower leg bracket 718, which is in tern affixed to one side of base 706. On the opposing side of the module cabinet a handle bracket 714 is attached, to which a handle 716 is attached to permit ease of carrying the inverter product. A key 712 may also be attached to adjoining cabinets to increase the stability of the set of cabinets.

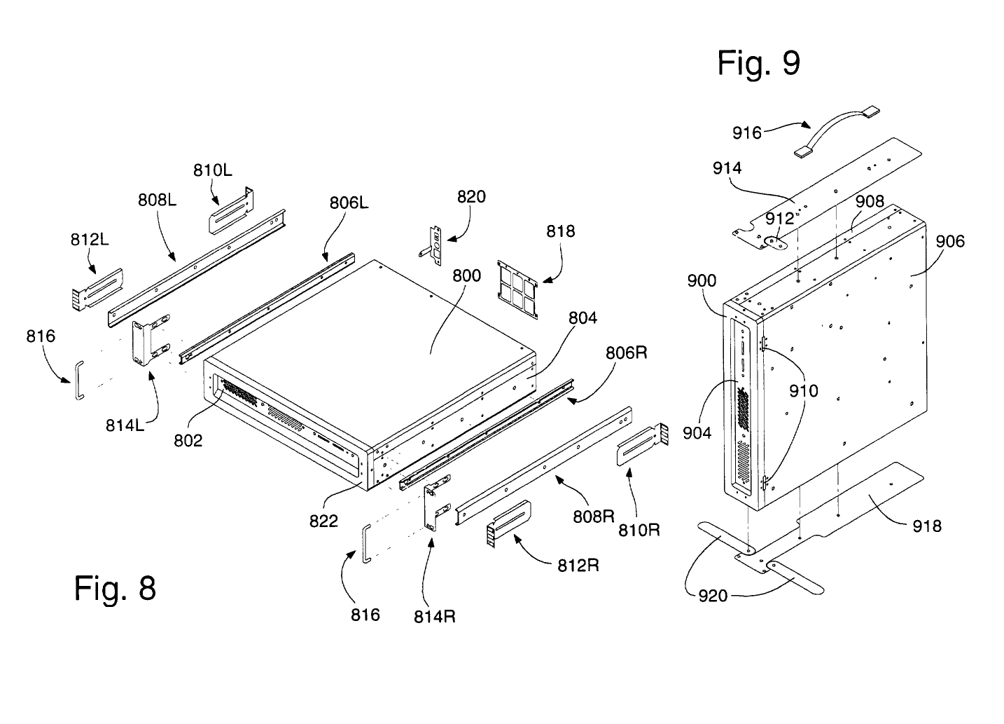

FIG. 8 illustrates an inverter product in a rack-mountable configuration, wherein inverter electronics are contained. An inverter product cabinet includes a top cover 800, a base 804, a bezel 822, and an insert 802. Inner slide rails 806R and 806L are fastened to base 804. Outer slide rails 808L and 808R are positionable to slide relative to inner slide rails 806R and 806L. Front mounting brackets 812R and 812L and rear mounting brackets 810R and 810L fasten to outer slide rails 808R and 808L and are securable to a rack cabinet. Rack mount brackets 814R and 814L fasten to the inverter product cabinet providing additional fastening points to secure the inverter product to a rack, fixing the module in the direction of the slide rail movement. Handles 816 may also be provided. Also shown are ethernet face plate 820 and outlet panel 818, which may be included in inverter product of this example.

FIG. 9 illustrates an inverter product in a floor mount configuration, the inverter product containing inverter electronics. An inverter product cabinet includes a top cover 908, a base 906, a bezel 900, and an insert 904. In this example hinges 910 provide connection from bezel 900 to base 906 and permit access to he interior of the inverter product cabinet by repositioning the front panel of components 900 and 904. Two opposing swing legs 920 are attached to a lower leg bracket 918, which is in turn affixed to one side of base 906. On the opposing side of the module cabinet a handle bracket 914 is attached, to which a handle 916 is attached to permit ease of carrying the inverter product. A key 912 may also be attached to adjoining cabinets to increase the stability of the set of cabinets.

In each of FIGS. 5, 7, and 9 the swing legs may be swung against the lower leg bracket to facilitate moving and setting the cabinets in positions other than resting against the swing legs.

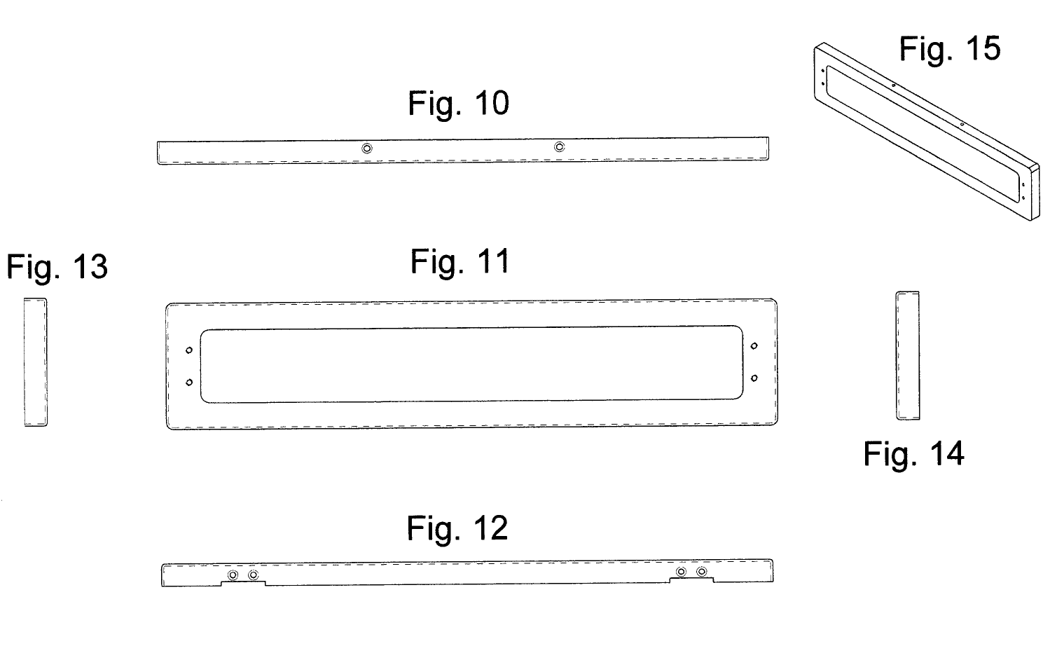

FIGS. 10, 11, 12, 13, 14, and 15 illustrate one example bezel that may be included in a cabinet assembly, the bezel having attachment points for hinges. FIG. 11 shows a front view. FIG. 10 shows a top view. FIG. 12 shows a bottom view. FIG. 13 shows a left side view, while FIG. 14 shows a right side view. Finally FIG. 15 shows a perspective view.

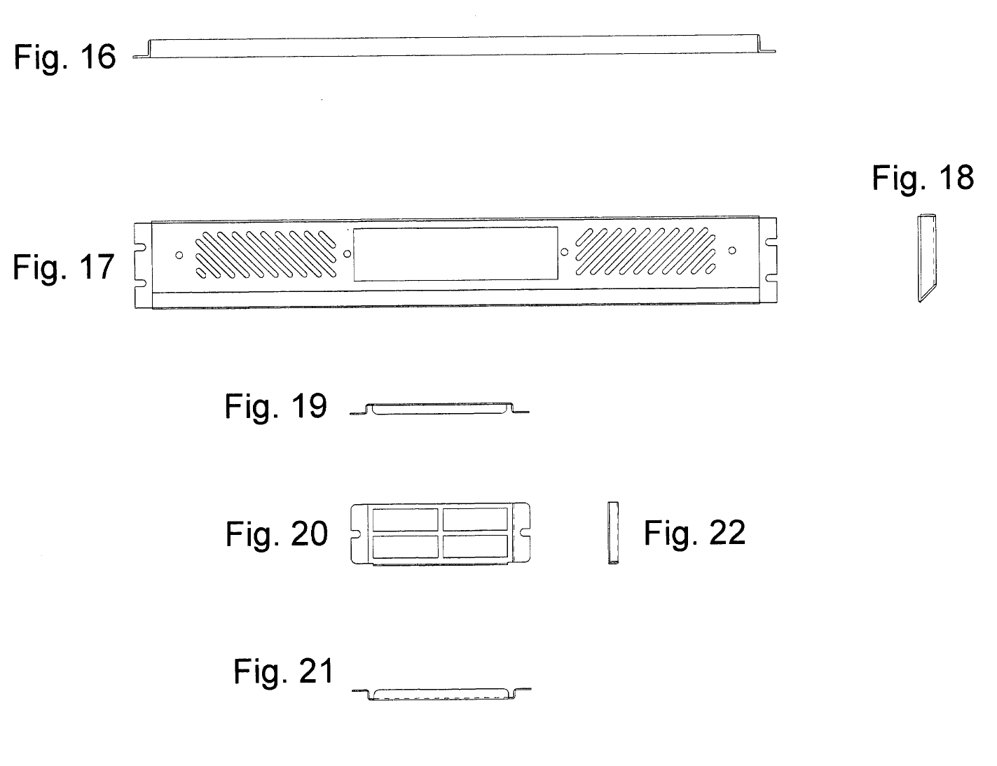

FIGS. 16, 17 and 18 illustrate an example insert that may be included in a battery module cabinet assembly. FIG. 17 shows a front view. FIG. 16 shows a top view. And FIG. 18 shows a right side view of the example insert.

FIGS. 19, 20, 21, and 22 illustrate an example filter bracket that may be combined with the insert of FIGS. 16, 17 and 18, the filter bracket capable of holding a filter. FIG. 20 shows a front view. FIG. 19 shows a top view, while FIG. 21 shows a bottom view. Finally FIG. 22 shows a right side view of the example filter bracket.

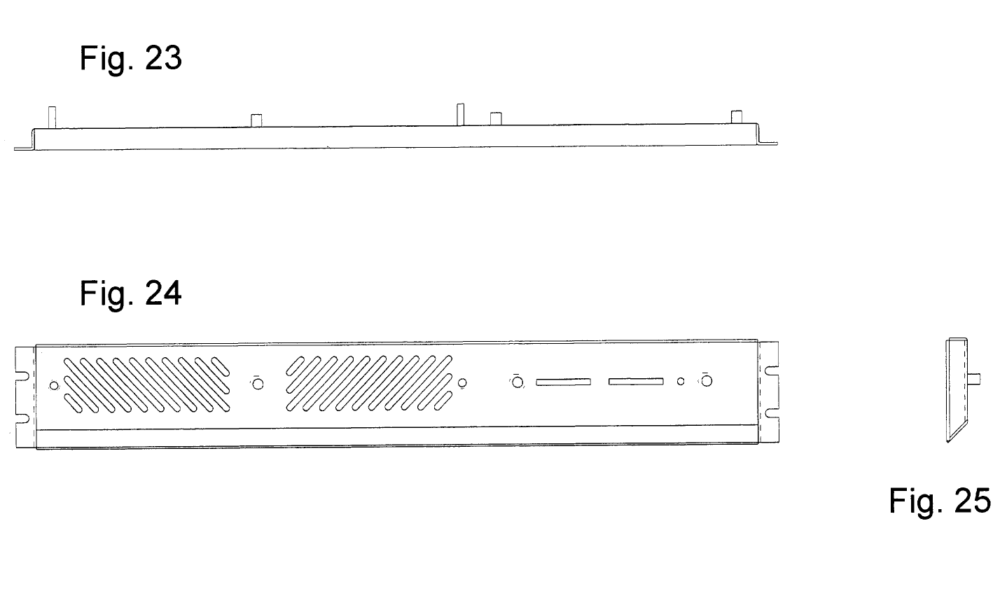

FIGS. 23, 24, and 25 illustrate an example insert that may be included in an inverter product cabinet assembly. FIG. 24 shows a front view. FIG. 23 shows a top view. FIG. 25 shows a right side view of that example insert.

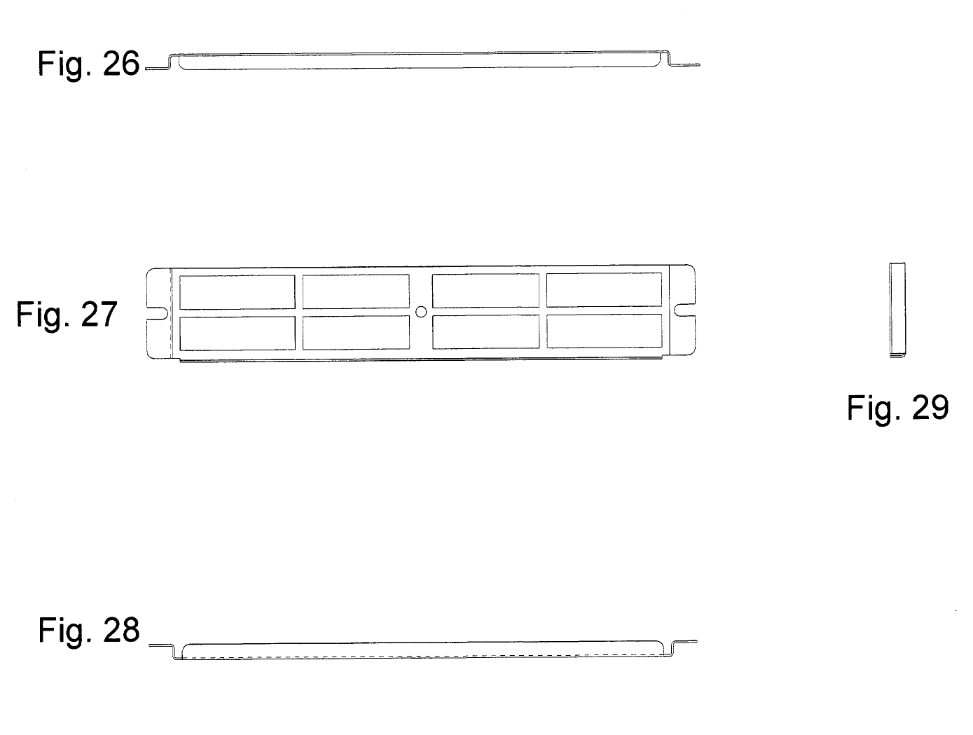

FIGS. 26, 27, 28, and 29 illustrate an example filter bracket that may be combined with the insert of FIGS. 23, 24 and 25, the filter bracket capable of holding a filter. FIG. 27 shows a front view. FIG. 26 shows a top view. FIG. 28 shows a bottom view. Finally FIG. 29 shows a right side view of the example filter bracket.

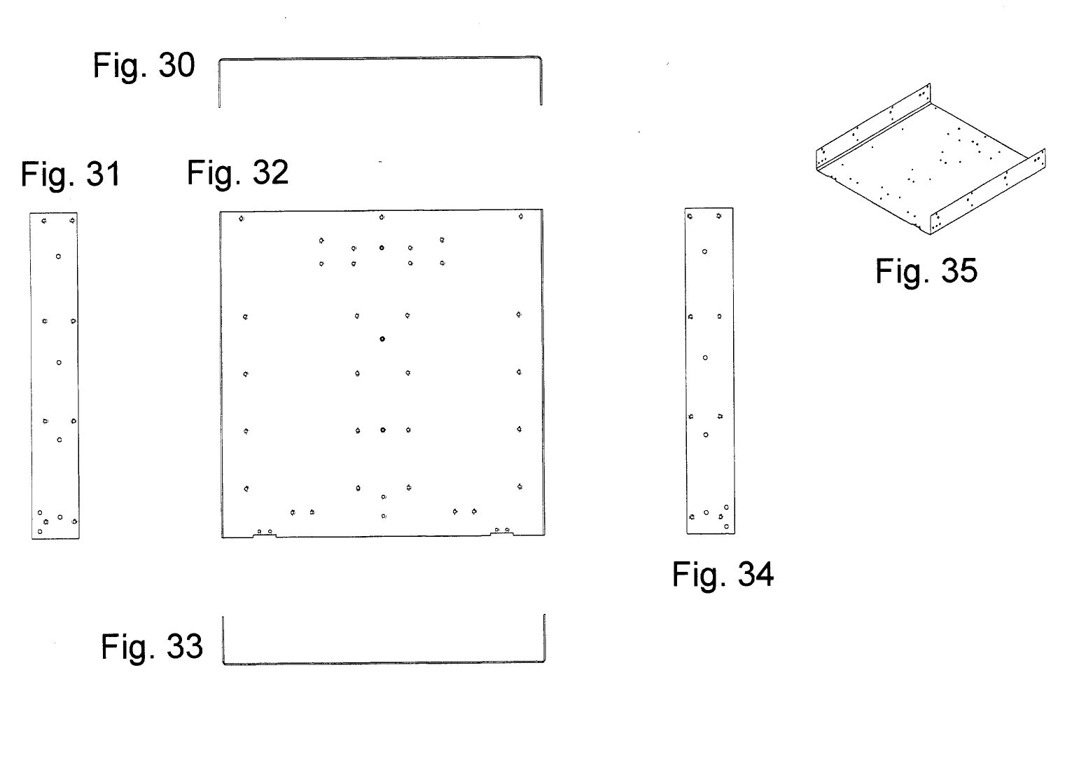

FIGS. 30, 31, 32, 33, 34, and 35 illustrate an example base for a battery module capable of holding two battery sleds in rails in the interior of the battery module cabinet. FIG. 32 shows a front view. FIG. 30 shows a top view, while FIG. 33 shows a bottom view. FIG. 31 shows a left side view. FIG. 34 shows a right side view. Finally, FIG. 35 shows a perspective view of that example battery module base.

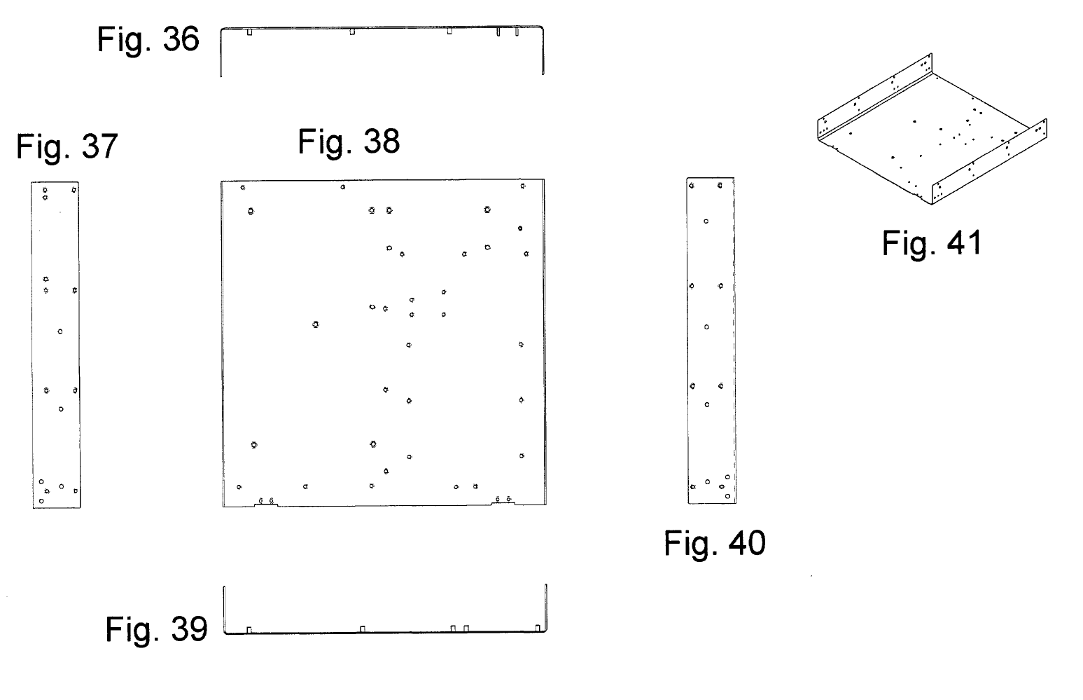

FIGS. 36, 37, 38, 39, 40, and 41 illustrate an example base for an inverter product capable of holding a single battery sled in rails in the interior of the inverter product cabinet. FIG. 38 shows a front view. FIG. 36 shows a top view. FIG. 39 shows a bottom view. FIG. 37 shows a left side view, and FIG. 40 shows a right side view. FIG. 41 shows a perspective view of that example inverter product base.

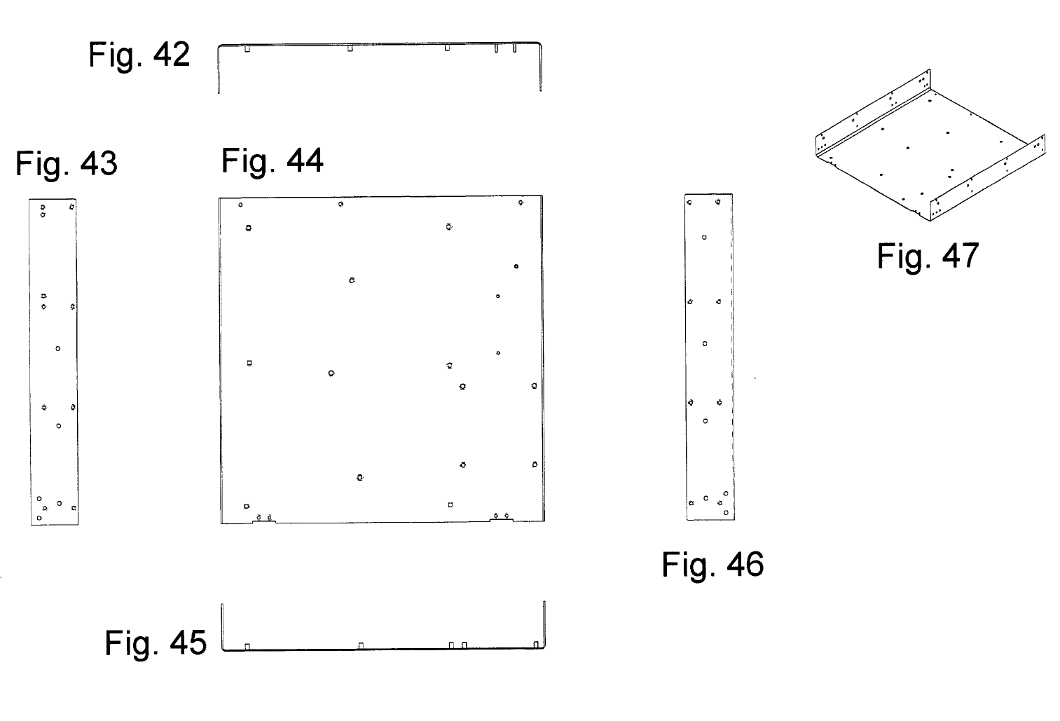

FIGS. 42, 43, 44, 45, 46 and 47 illustrate an example base for a battery module cabinet capable of receiving rack mounts or swing-leg mounts as described above. FIG. 44 shows a front view. FIG. 42 shows a top view. FIG. 45 shows a bottom view. FIG. 43 shows a left side view. FIG. 46 shows a right side view. Finally FIG. 47 shows a perspective view of that battery module base.

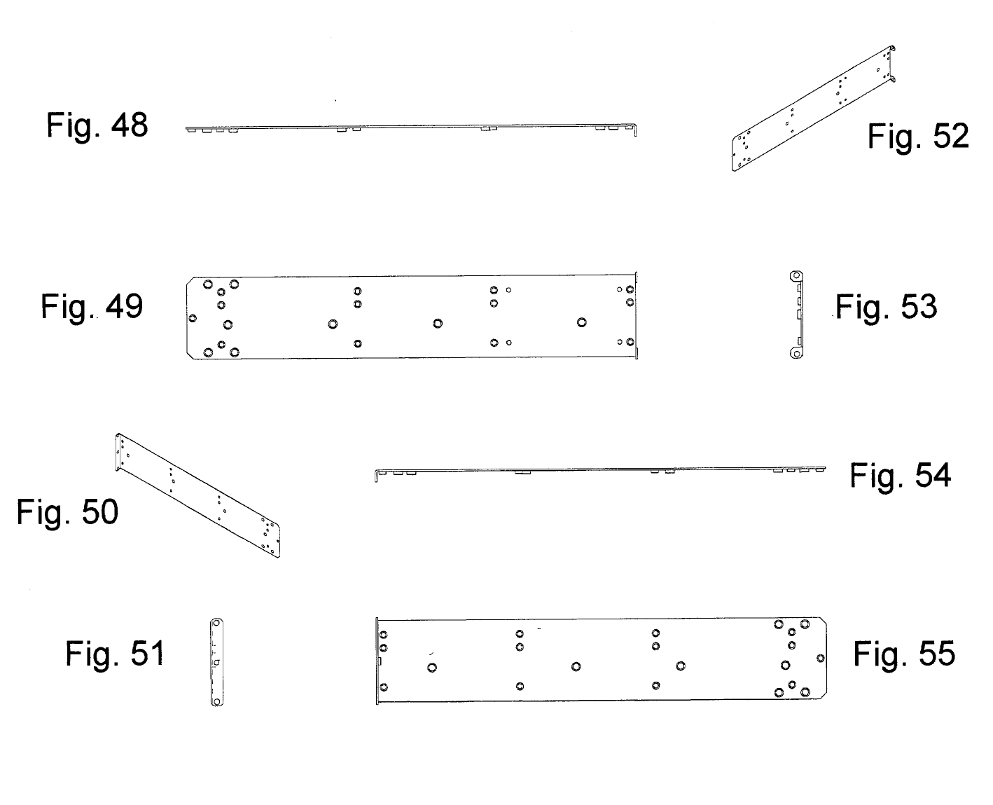

FIGS. 48, 49, 52, and 53 illustrate an example left side bracket that may be included in one of the illustrated inverter product cabinets. FIG. 49 shows a front view. FIG. 48 shows a top view. FIG. 53 shows a right side view, and finally FIG. 52 shows a perspective view of that left side bracket.

FIGS. 50, 51, 54, and 55 illustrate an example right side bracket that may be included in a battery module or inverter product cabinet. FIG. 55 shows a front view. FIG. 54 shows a top view. FIG. 51 shows a left-side view. FIG. 50 shows a perspective view of that example right side bracket.

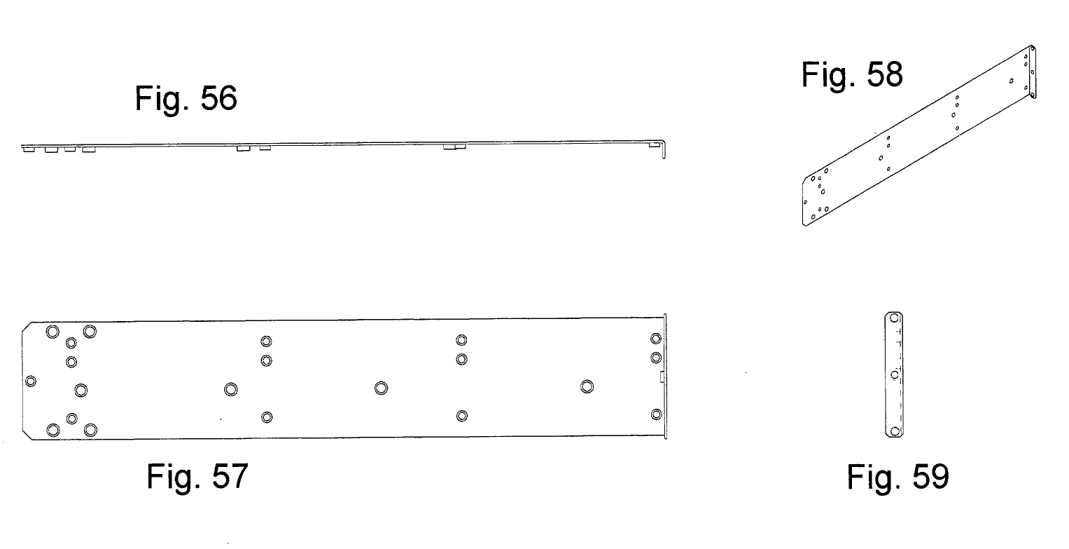

FIGS. 56, 57, 58, and 59 show another example left side bracket that may be included in one of the illustrated battery module products. FIG. 57 shows a front side view, while FIG. 56 shows a top side view. FIG. 59 shows a right side view. Finally, FIG. 58 shows a perspective view of that example left side bracket.

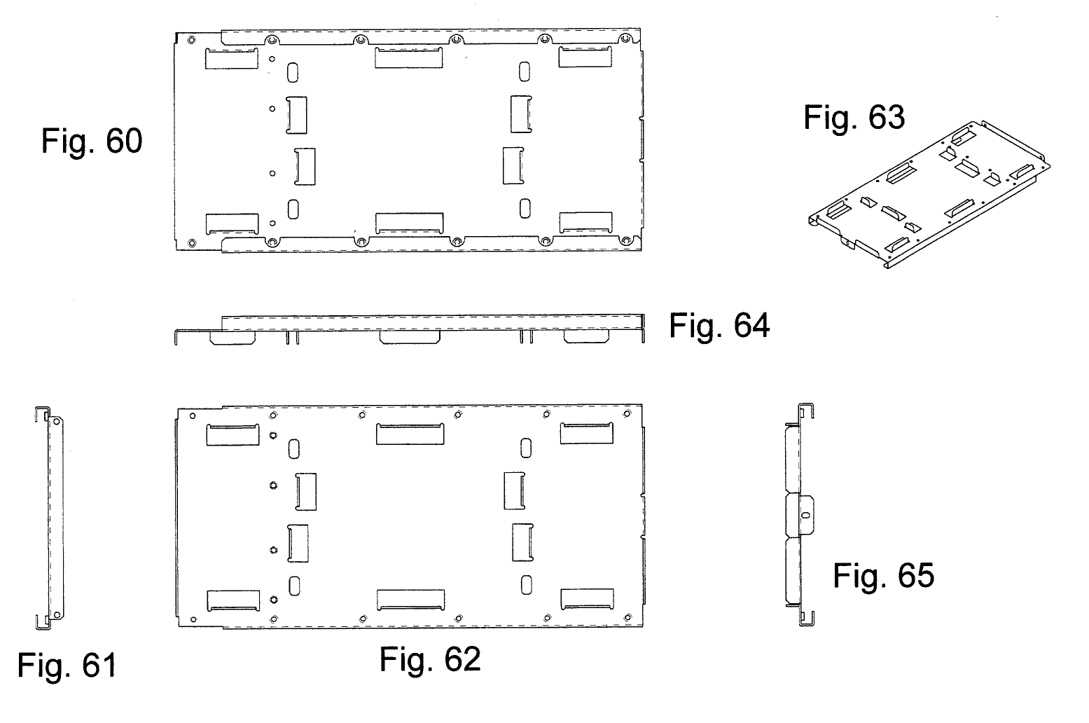

FIGS. 60, 61, 62, 63, 64, and 65 illustrate an example removable sled base providing alignment within some battery-containing products of the invention. FIG. 62 shows a front side view. FIG. 64 shows a top view. FIG. 60 shows a rear view. FIG. 61 shows a left side view, while FIG. 65 shows a right side view. FIG. 63 shows a perspective view of that example sled base.

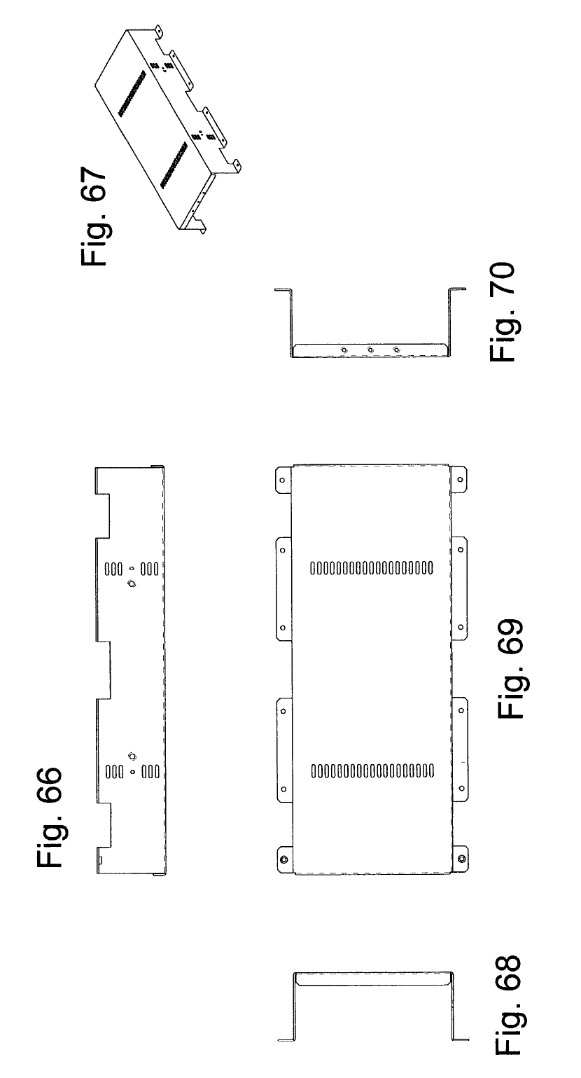

FIGS. 66, 67, 68, 69, and 70 illustrate a sled top cover that may be combined with the sled base of FIGS. 60, 61, 62, 63, 64 and 65 to contain one or more batteries. FIG. 69 shows a front view, while FIG. 66 shows a top view. FIG. 68 shows a left side view, and FIG. 70 shows a right side view. FIG. 67 shows a perspective view of that sled top cover.

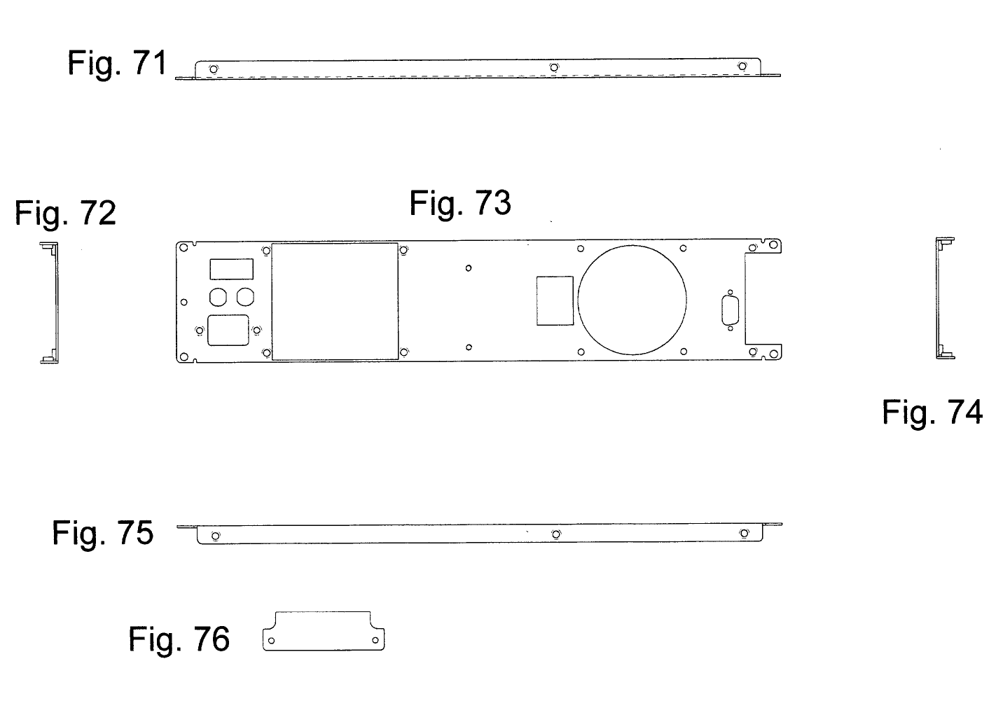

FIGS. 71, 72, 73, 74 and 75 show an example rear panel of an inverter product. FIG. 73 shows a front view. FIG. 71 shows a top view. FIG. 72 shows a left side view, while FIG. 74 shows a right side view. Finally, FIG. 75 shows a bottom view of that example rear panel.

FIG. 76 illustrates a filler panel for a rear panel having a fitting for an ethernet panel.

FIGS. 77, 78, 79, 80, and 81 illustrate an example rear panel of a battery module. FIG. 79 shows a front side view. FIG. 77 shows a top view, and FIG. 81 shows a bottom view. FIG. 78 shows a left side view, and FIG. 80 shows a right side view of that example rear panel.

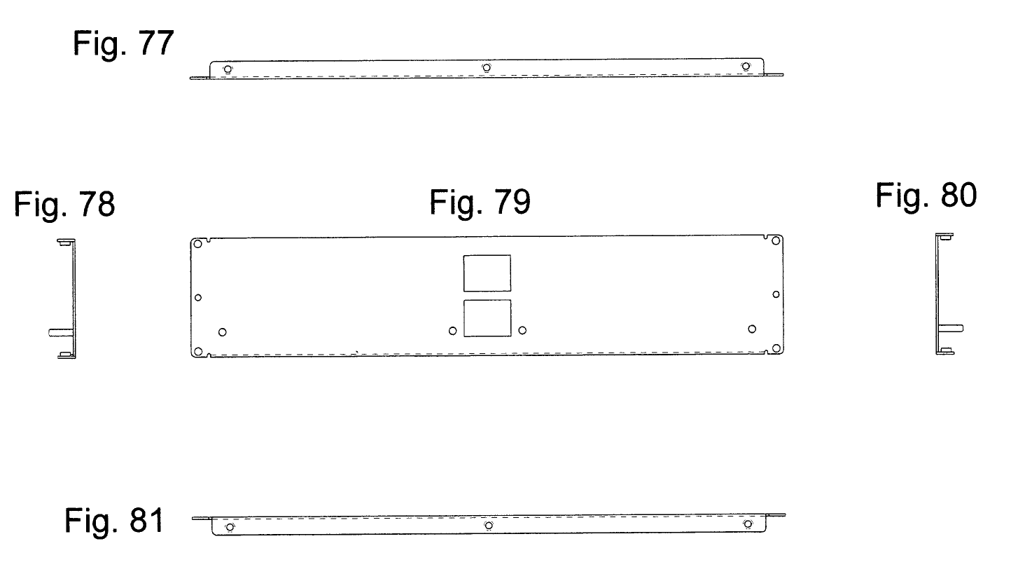

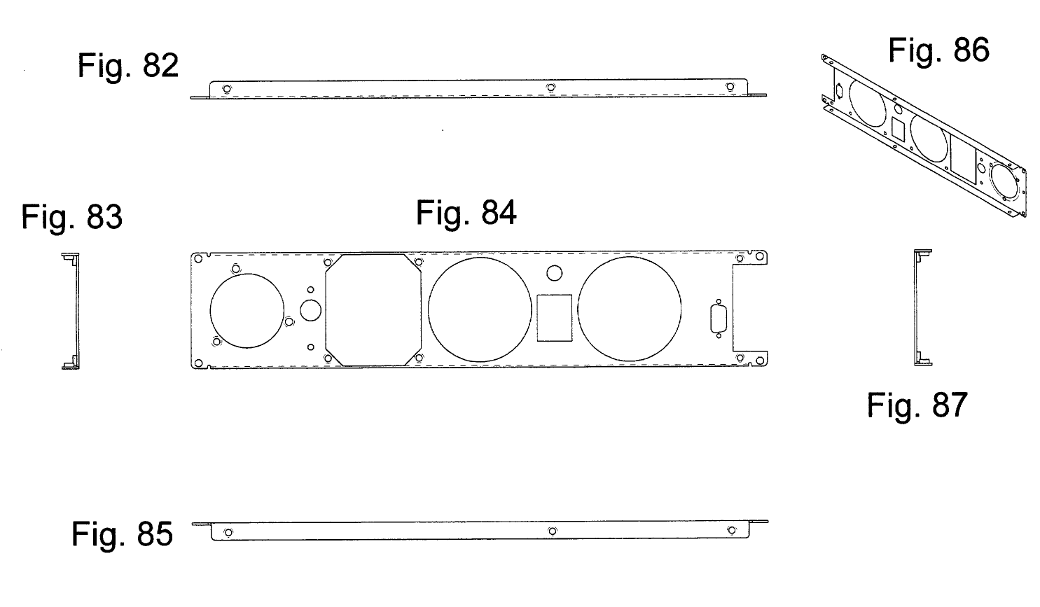

FIGS. 82, 83, 84, 85, 86, and 87 show an example rear panel of an inverter product. FIG. 84 shows a front view. FIG. 82 shows a top view, while FIG. 85 shows a bottom view. FIG. 83 shows a left side view. FIG. 87 shows a right side view. FIG. 86 shows a perspective view of that inverter product rear panel.

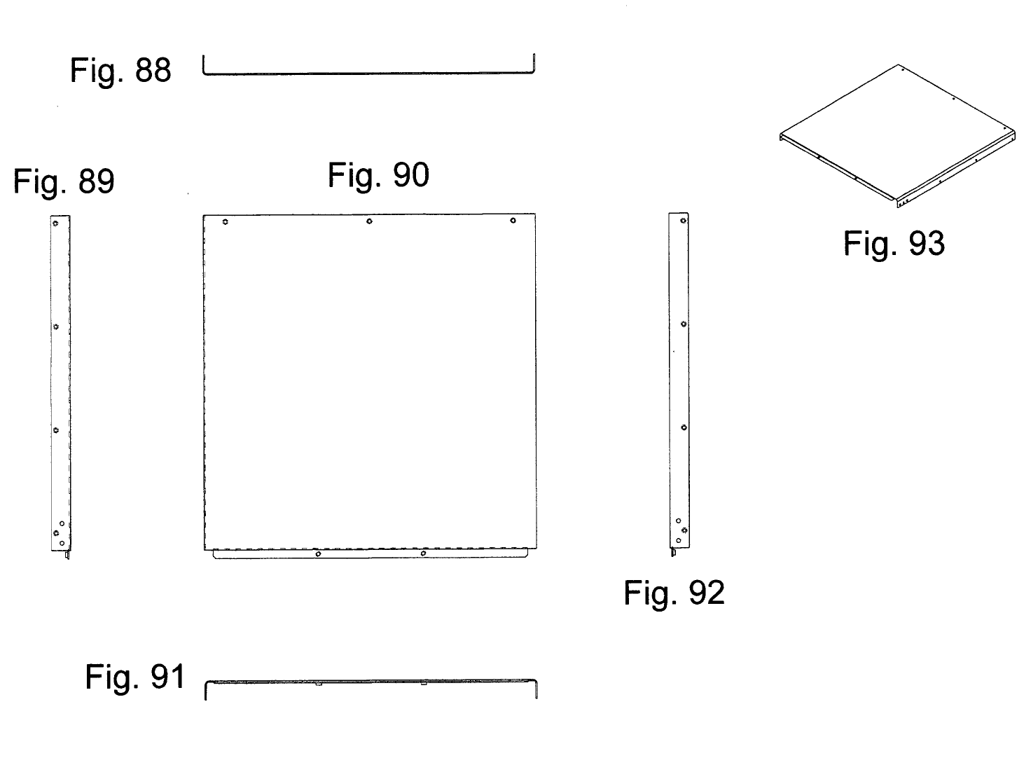

FIGS. 88, 89, 90, 91, 92, and 93 illustrate an example top cover suitable for illustrated examples of battery modules and inverter products. FIG. 90 shows a front view. FIG. 88 shows a top view, and FIG. 91 shows a bottom view. FIG. 89 shows a left side view. FIG. 92 shows a right side view. FIG. 93 finally shows a perspective view of that example top cover.

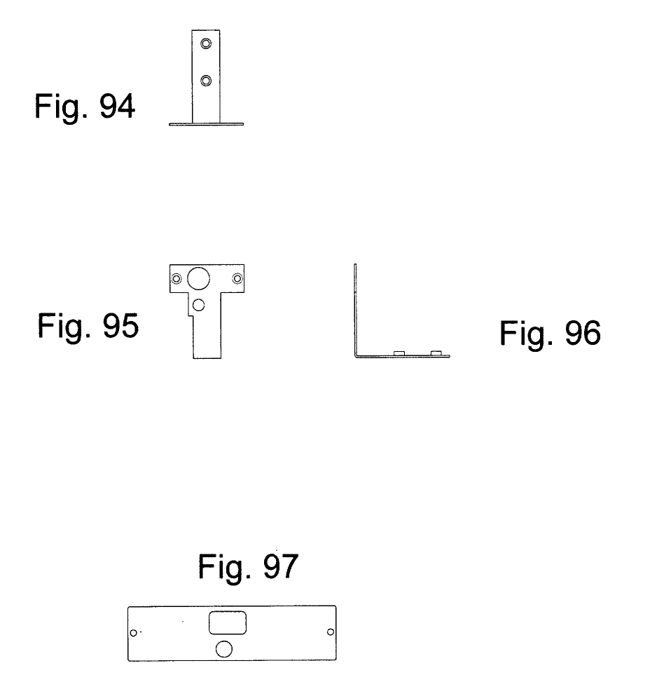

FIGS. 94, 95 and 96 illustrate an example breaker bracket of a battery module, the bracket capable of receiving a circuit breaker. FIG. 95 shows a front view. FIG. 94 shows a top view, while FIG. 96 shows a right side view of that example breaker bracket.

FIG. 97 shows the front side of a breaker panel that may be combined with a breaker bracket of the illustrated examples of the invention.

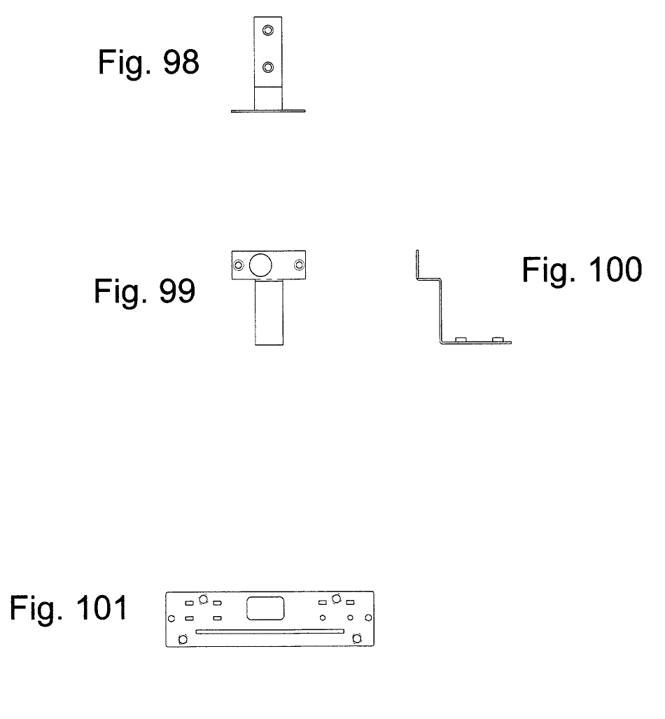

FIGS. 98, 99, 100 and 101 illustrate another example breaker bracket capable of receiving a circuit breaker. FIG. 99 shows a front view. FIG. 98 shows a top view. FIG. 100 shows a right side view of that example breaker bracket.

FIG. 101 shows a front side view of another example breaker panel that may be combined with a breaker bracket of illustrated examples of the invention.

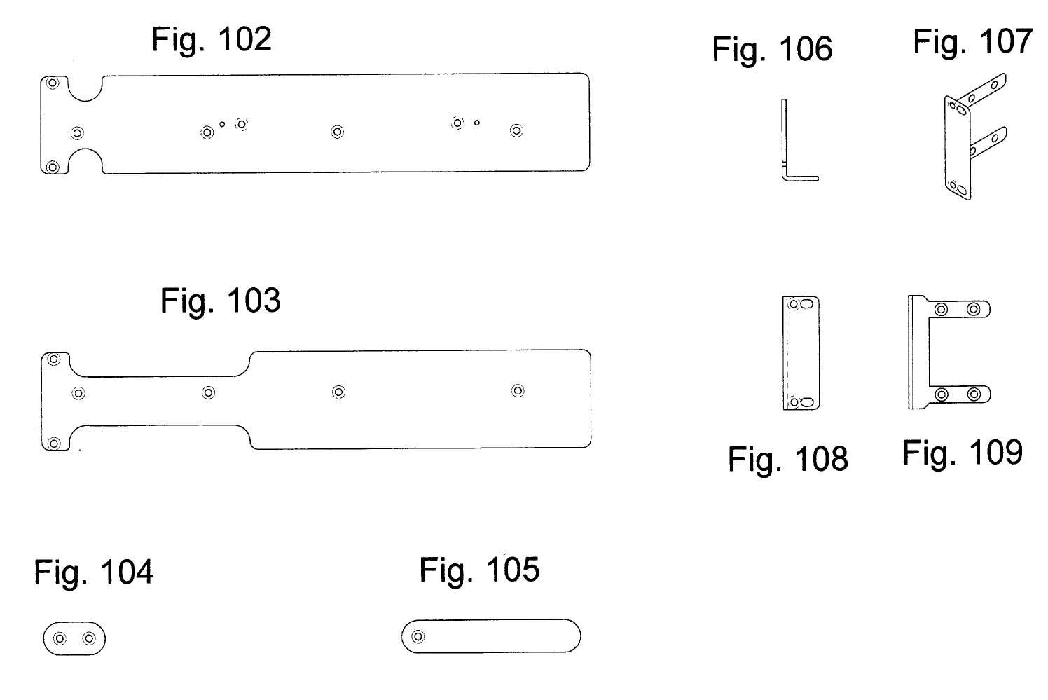

FIG. 102 shows a lower leg bracket capable of receiving swing legs and mountable to a cabinet. FIG. 103 shows an alternate lower leg bracket.

FIG. 104 depicts a top key for securing adjacent cabinets utilizing a swing leg stand.

FIG. 105 shows a swing leg of the illustrated cabinet mounting examples.

FIGS. 106, 107, 108 and 109 show an example rack mount bracket for mounting a cabinet to a rack. FIG. 108 shows a front view. FIG. 106 shows a top view. FIG. 109 shows a right side view, and FIG. 107 shows a perspective view of that rack mount bracket.

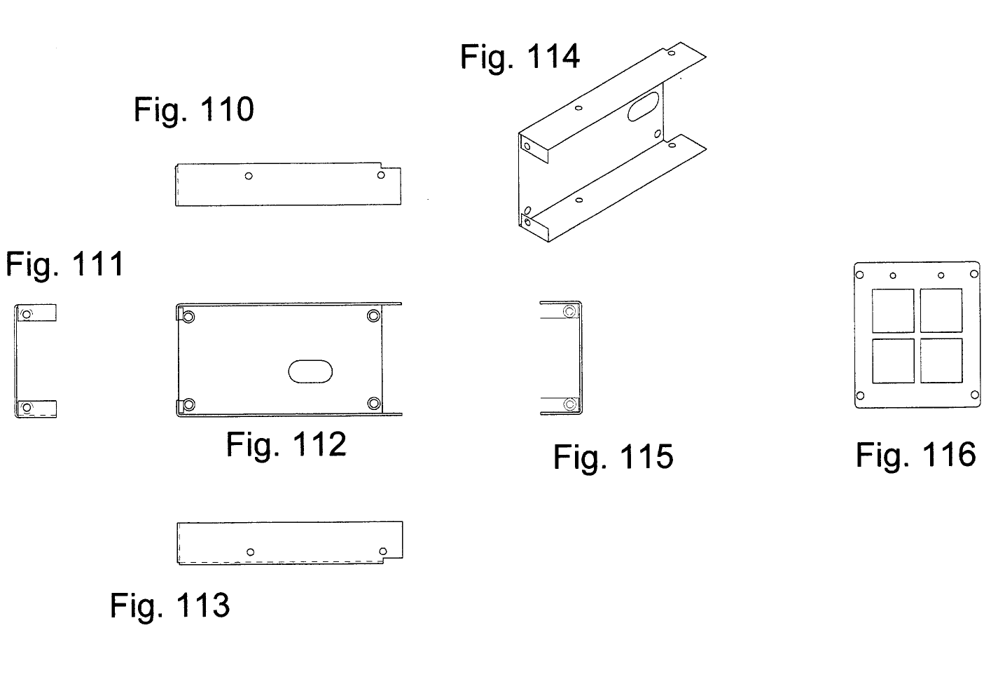

FIGS. 110, 111, 112, 113, 114, and 115 show an example ethernet bracket of the illustrated products. FIG. 112 is a front side view. FIG. 110 is a top view, while FIG. 113 is a bottom view. FIG. 111 is a left side view, and FIG. 115 is a right side view. Finally FIG. 114 is a perspective view of that example ethernet bracket.

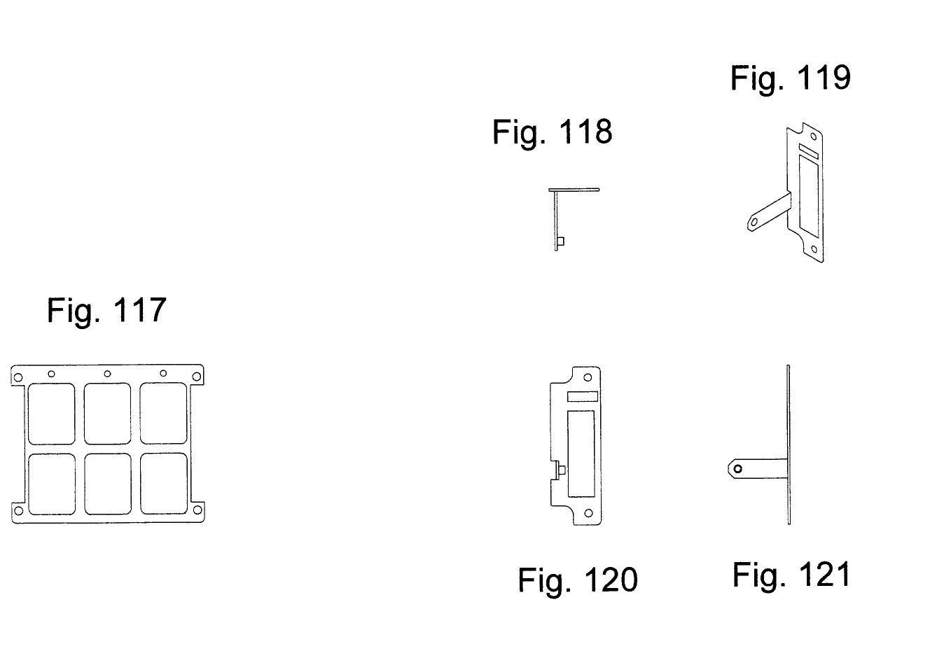

FIG. 116 depicts one outlet panel that may receive outlets and is mountable to some inverter products. FIG. 117 depicts an alternate outlet panel used on other inverter products.

FIGS. 118, 119, 120, and 121 show an example face plate that may be used in illustrated examples of inverter products. FIG. 120 shows a front side view. FIG. 118 shows a top view, while FIG. 121 shows a right side view. FIG. 119 shows a perspective view of that example face plate.

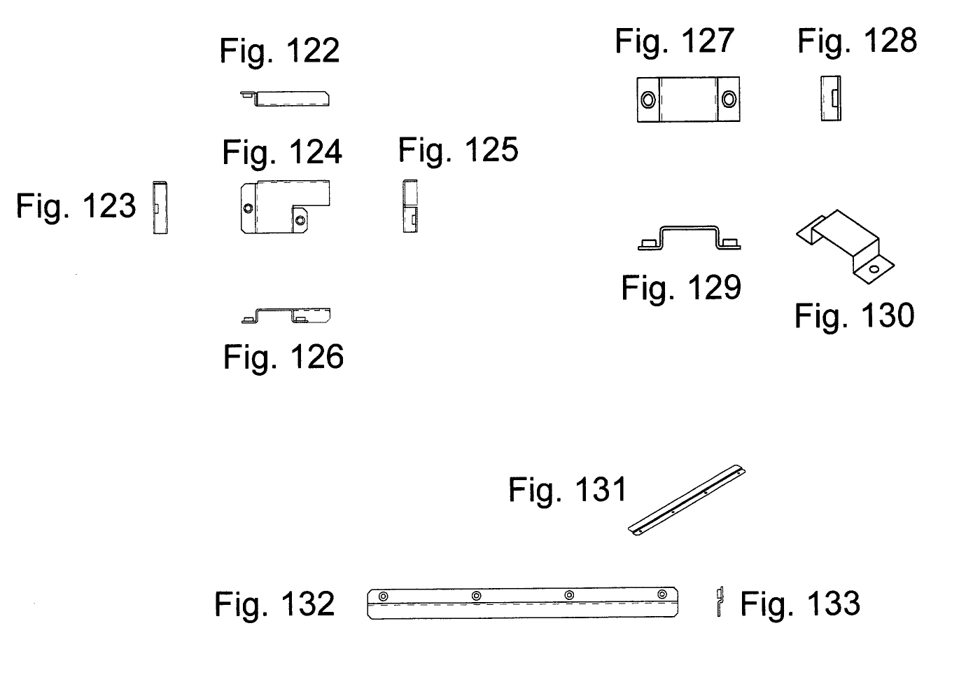

FIGS. 122, 123, 124, 125 and 126 show an example left wire channel of illustrated products. FIG. 124 shows a front view. FIG. 122 shows a top view, while FIG. 126 shows a bottom view. FIG. 123 shows a left side view, and FIG. 125 shows a right side view of that example left wire channel. A right wire channel may be constructed using the mirror-image of a left wire channel.

FIGS. 127, 128, 129, and 130 illustrate a connector top bracket that may be used to house connectors. FIG. 127 shows a front side view. FIG. 128 shows a right side view, and FIG. 129 shows a bottom view. FIG. 130 shows a perspective view of that connector top bracket.

FIGS. 131, 132 and 133 show a sled rail that may be used in illustrated products. FIG. 132 shows a front side view, while FIG. 133 shows a right side view. FIG. 131 shows a perspective view of that sled rail.

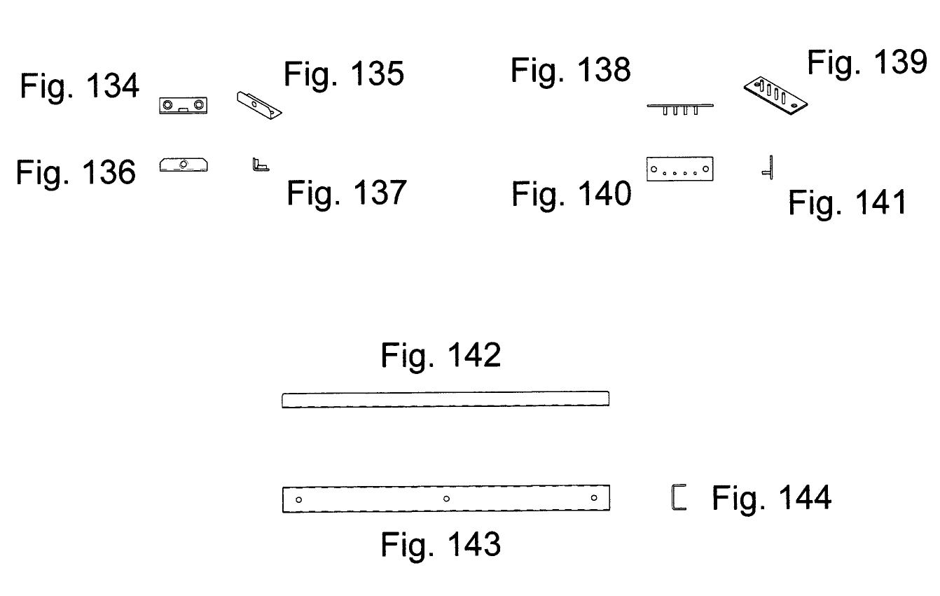

FIGS. 134, 135, 136 and 137 illustrate an example sled stop bracket. FIG. 136 shows a front side view. FIG. 134 shows a top view, while FIG. 137 shows a right side view. FIG. 135 shows a perspective view of that sled stop bracket.

FIGS. 138, 139, 140 and 141 show a connector bottom bracket that may be combined with the connector top bracket of FIGS. 127, 128, 129 and 130. FIG. 140 shows a front side view. FIG. 138 shows a top view, and FIG. 141 shows a right side view. FIG. 139 shows a perspective view of that connector bottom bracket.

FIGS. 142, 143 and 144 show a center wire channel of illustrated products. FIG. 143 shows a front side view. FIG. 142 shows a top view, and FIG. 144 shows a right side view of that center wire channel.

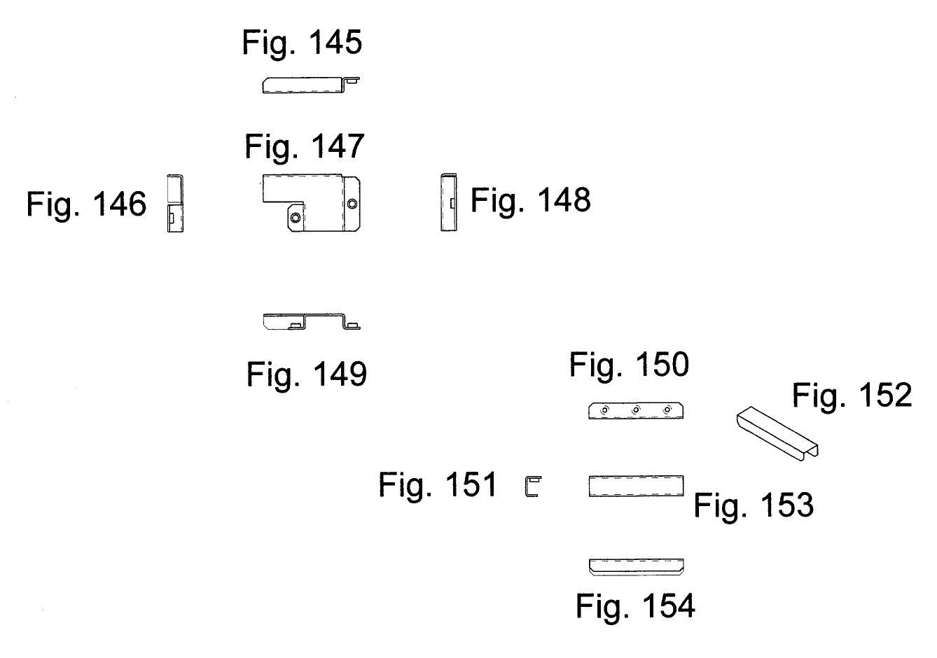

FIGS. 145, 146, 147, 148 and 149 show an example right wire channel. FIG. 147 shows a front side view. FIG. 145 shows a top view, while FIG. 149 shows a bottom view. FIG. 146 shows a left side view, and FIG. 148 shows a right side view of that right wire channel.

FIGS. 150, 151, 152, 153 and 154 show a sled handle bracket that may be attached to a battery sled. FIG. 153 shows a front view. FIG. 150 shows a top view, and FIG. 154 shows a bottom view. FIG. 151 shows a left side view, while FIG. 153 shows a right side view. Finally, FIG. 152 shows a perspective view of that sled handle bracket.

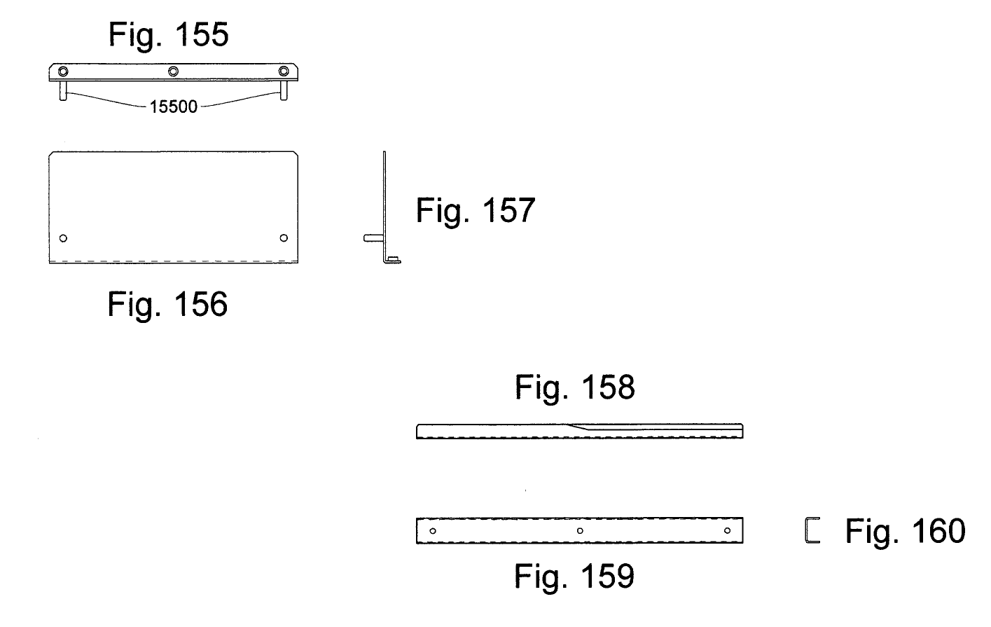

FIGS. 155, 156 and 157 show an example sled alignment bracket of the illustrated products. FIG. 156 shows a front side view, while FIG. 155 shows a top view. FIG. 157 shows a right side view of that sled alignment bracket. Alignment pins 15500 may be tapered at the ends to assist the insertion of the pins into corresponding apertures in a battery sled enclosure.

FIGS. 158, 159, and 160 illustrate an alternate sled rail with improved ease of alignment. FIG. 159 shows a front side view. FIG. 158 shows a top side view. FIG. 160 shows a right side view. The rail of this sled rail has reduced width at the front of the rail to ease entry of a sled base on to the rails. The rail is tapered to full width at the rear, permitting firm alignment prior to the mating of the electrical connectors.

A battery protection system may also be incorporated into products of the invention which monitors and controls battery energy levels and prohibits depletion of energy beyond a compromising level by disconnecting loads. After energy returns to levels above the compromising level loads may be re-enabled. This procedure reduces dead and damaged batteries caused by prolonged and accidental loads.

One system of the invention monitors voltage levels under load, disabling the load once voltage levels reach a compromising point. In that system the compromising point is programmable, although in other systems the point may be merely adjustable or fixed. That system may be easily modified to support various loads and battery types. After a charge voltage is sensed and safe voltage levels are reached, that system automatically resets and reconnects loads until the compromise level is reached again.

In some battery protection systems of the invention a display is continuously updated showing voltage levels. Other systems go into an energy conservation sleep mode when activity is not sensed for a period of time. Other systems provide remote displays that communicate with a processor through a remote connection.

In some battery protection systems of the invention an emergency two-minute override switch allows a user to reconnect loads for two minutes. Other systems with different override periods are considered, and within the inventive concepts.

FIG. 160 illustrates a battery protection system of the invention, the battery charging circuit and ground connections being omitted. A processor 16108 includes software to operate the battery protection procedure. In a preferred embodiment processor 16108 is a PIC16F876 available from Microchip Technology Inc. of Chandler, Ariz. Processor 16108 is supplied with regulated voltage by voltage regulator 16104, which receives its supply from the battery under supervision, 16140. The voltage of battery 16140 is monitored through a voltage divider 16100, which converts the voltage range of battery 16140 to a lesser range within the available sensing voltage range of processor 16108. If the maximum voltage of battery 16140 is within the input range of processor 16108, the voltage divider may take the form of a direct connection. In a preferred embodiment, two resistors of 10,000 ohms or greater are used in voltage divider 16100 to reduce parasitic losses in the circuit while maintaining low production costs. A potentiometer 16102 is tied to the output voltage of voltage regulator 16104 and ground, with the wiper leg fed to processor 16108. Adjustment of potentiometer 16102 provides a settable voltage threshold. In a preferred embodiment, the wiper output of potentiometer 16102 and the output of voltage divider 16100 are fed to a comparator circuit internal to processor 16108, although other methods of comparing battery voltage to a voltage threshold, such as the use of ADCs, are considered within the scope of the invention.

A relay 16138 is tied to the positive side of battery 16140 providing current switching to an output line 16142. Relay 16138 is also preferably a flip-flop, such that continuous voltages or currents are not required to maintain either the on or off state of the relay 16138. In that preferable configuration pulses of voltage may be used to change relay state, avoiding additional parasitic power losses. In that configuration MOSFET transistors are used with a low on-resistance to increase efficiency and reduce the need for dissipation of heat. In a preferred embodiment IRF9234 and IRLZ44 transistors from International Rectifier of El Segundo, Calif. are used in the relay.

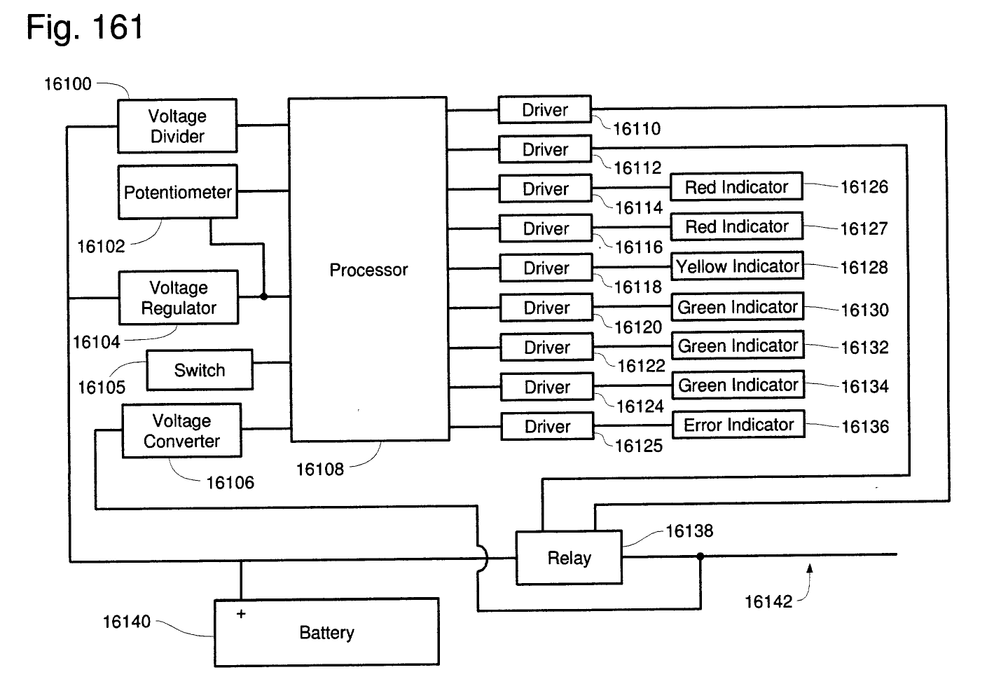

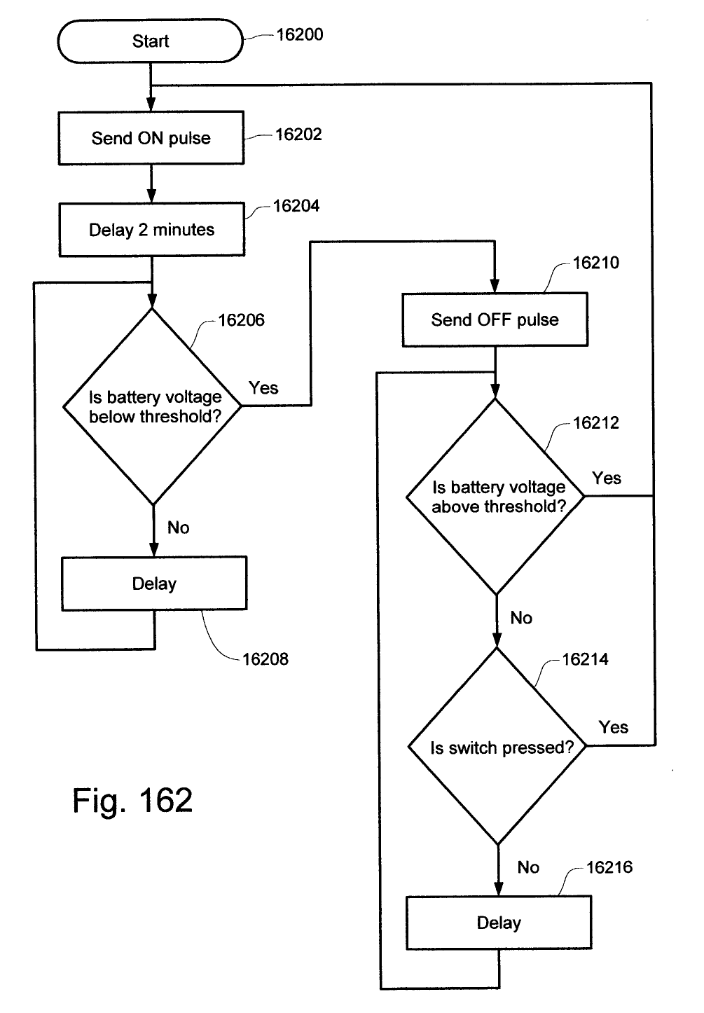

Relay 16138 may utilize drivers 16110 and 16112 to convert voltage and current levels, and to provide electrical isolation in the event of a failure of relay 16138. Opto-isolators are preferably used. If the inputs of relay 16138 are compatible with the output voltages and currents of processor 16108, and no electrical isolation is needed, drivers 16110 and 16112 may be omitted. Processor 16108 may be fed with the condition of the output line 16142 by providing a voltage converter 16106 to down-convert the voltage to suitable levels for processor 16108. Processor 16108 senses the voltage of output line 16142 through voltage converter 16106. A switch 16105 may be supplied to allow relay 16138 to remain in the on condition for a period of time after battery depletion; in a preferred embodiment that period is two minutes. A number of indicators 16126, 16127, 16128, 16130, 16132, 16134, and 16136 may also be provided to show the voltage level of either the battery 16140 or the output line 16142. In the example of FIG. 161 three colors of indicators are used: green indicating high voltage levels, yellow indicating marginal voltage levels, and red indicating critical voltage levels. An error indicator 16136 may also be driven by processor 16108 to show the presence of an error state. Drivers 16114, 16116, 16118, 16120, 16124, and 16125 may be included if the voltage and current requirements of the indicators exceed or are exceeded by the voltage and current outputs of processor 16108. In a preferred embodiment the indicators are current limited light emitting diodes.

FIG. 161 illustrates a battery protection procedure that may be implemented in the system of FIG. 160, or other systems in the scope of the invention. The procedure begins at step 16200 which falls through to step 16202, in which an ON pulse is sent to the relay. Step 16204 then executes delaying for a period of time, in this case two minutes. Steps 16202 and 16204 form the basis of a two minute delay on a user button press. In an alternate implementation the button is connected to the reset line of the processor. In other procedures the sending of an ON pulse may be delayed until after the battery voltage has been verified to be above the threshold. Following step 16204 step 16206 executes, in which the battery voltage is checked. If the battery voltage is above the threshold, step 16208 executes delaying for a short period of time, after which the loop repeats at step 16206. If the battery voltage is below the threshold, step 16210 executes in which an OFF pulse is sent to the relay. Execution then proceeds to step 16212 in which the battery voltage is compared to the threshold. If the battery voltage is below the threshold, step 16214 is executed in which a switch is read. If the switch is not pressed, step 16216 executes a delay and a loop repeats at step 16212. If in step 16212 the battery voltage is above the threshold or in step 16214 the switch is pressed, execution proceeds to step 16202 which sends an ON pulse, and the procedure repeats.

While the present invention has been described and illustrated in conjunction with a number of specific embodiments, those skilled in the art will appreciate that variations and modifications may be made without departing from the principles of the inventions as herein illustrated, described and claimed.

The present invention may be embodied in other specific forms without departing from their spirit or characteristics. The described embodiments are to be considered in all respects as only illustrative, and not restrictive. The scope of the invention is, therefore, indicated by the appended claims, rather than the foregoing description. All changes that come within the meaning and range of equivalency of the claims are to be embraced within their scope.

1. A cabinet structure suitable for containing at least one battery, the cabinet structure providing access to at least one set of battery mountings from the front of the cabinet, the structure further mountable to a standard rack structure having rails for securing rack-mountable components, the cabinet structure comprising:
a cabinet having a front side, said cabinet also having a left side and a right side, said cabinet further having a dimension between said left and right side sufficient for inserting and securing the cabinet to the rack structure, said cabinet having an interior suitable for containing at least one battery enclosure;
at least one set of rack mountings suitable for securing said cabinet to the rack structure rails;
a front panel;
a front panel mounting providing a normal position and at least one alternate position of said front panel, said front panel mounting providing a mechanical connection in the normal position from said panel to said cabinet such that said panel is located to the front side of said cabinet, said front panel mounting providing for repositioning of said front panel to the alternate positions whereby access may be provided to the interior of said cabinet from the front side;
and at least one set of battery mountings suitable for securing a battery enclosure to the interior of said cabinet, said battery mountings permitting the insertion and removal of a battery enclosure when said front panel is in an alternate position.

2. The cabinet structure of claim 1, wherein:
said cabinet has a dimension between said left and right sides suitable for inserting and securing the cabinet to a rack structure conforming to the EIA-310 standard.

3. The cabinet structure of claim 1, wherein the battery mountings further comprise:
two opposing rails, said rails accepting slides formed in a battery enclosure.

4. The cabinet structure of claim 3, further comprising:
at least one battery enclosure having slides, said slides configured to maintain the position of the battery enclosure relative to said rails in directions orthogonal to the direction of sliding motion.

5. The cabinet structure of claim 1, further comprising:
at least one stop, said stop preventing motion of a battery enclosure beyond a stop position.

6. The cabinet structure of claim 1, wherein said front panel mounting further comprises:
at least one hinge, said hinge pivotably connecting said front panel to said cabinet.

7. The cabinet structure of claim 1, further comprising:
a restraining device attached to said cabinet, said device being configurable to fix the position of said front panel in the normal position.

8. The cabinet structure of claim 1, further comprising:
an inverter interior to said cabinet;
and an outlet panel included in said cabinet.

9. The cabinet structure of claim 1, wherein said rack mountings comprise:
slide rails attached to the left and right sides of said cabinet;
and mounting brackets attaching to said slide rails;

10. The cabinet structure of claim 1, further comprising:
a stand attached to either the left or right sides of said cabinet, said stand having at least two opposing horizontal legs.

11. The cabinet structure of claim 10, further comprising:
a handle attached to said cabinet at the side opposite said stand.

12. A cabinet structure suitable for containing at least one battery, the cabinet structure providing access to at least one set of battery mountings from the front of the cabinet, the structure further mountable to a standard 19 inch EIA-310 rack structure having rails for securing rack-mountable components, the cabinet structure comprising:
a cabinet having a front side, said cabinet also having a left side and a right side, said cabinet further having a dimension between said left and right side sufficient for inserting and securing the cabinet to the rack structure, said cabinet having an interior suitable for containing at least one battery enclosure;
at least one set of rack mountings suitable for securing said cabinet to the rack structure rails;
a front panel;
a front panel mounting providing a normal position and at least one alternate position of said front panel, said front panel mounting providing a mechanical connection in the normal position from said panel to said cabinet such that said panel is located to the front side of said cabinet, said front panel mounting providing for repositioning of said front panel to the alternate positions whereby access may be provided to the interior of said cabinet from the front side;
and at least one set of battery mountings suitable for securing a battery enclosure to the interior of said cabinet, said battery mountings permitting the insertion and removal of a battery enclosure when said front panel is in an alternate position.

13. The cabinet structure of claim 12, wherein the battery mountings further comprise:
two opposing rails, said rails accepting slides formed in a battery enclosure.

14. The cabinet structure of claim 13, further comprising:
at least one battery enclosure having slides, said slides configured to maintain the position of the battery enclosure relative to said rails in directions orthogonal to the direction of sliding motion.

15. The cabinet structure of claim 12, further comprising:
at least one stop, said stop preventing motion of a battery enclosure beyond a stop position.

16. The cabinet structure of claim 12, wherein said front panel mounting further comprises:
at least one hinge, said hinge pivotably connecting said front panel to said cabinet.

17. The cabinet structure of claim 12, further comprising:
a restraining device attached to said cabinet, said device being configurable to fix the position of said front panel in the normal position.

18. The cabinet structure of claim 12, further comprising:
an inverter interior to said cabinet;
and an outlet panel included in said cabinet.

19. A cabinet structure suitable for containing at least one battery, the cabinet structure providing access to at least one set of battery mountings from the front of the cabinet, the structure further mountable to a standard 19 inch EIA-310 rack structure having rails for securing rack-mountable components, the cabinet structure comprising:
a cabinet having a front side, said cabinet also having a left side and a right side, said cabinet further having a dimension between said left and right side sufficient for inserting and securing the cabinet to the rack structure, said cabinet having an interior suitable for containing at least one battery enclosure;
at least one set of rack mountings suitable for securing said cabinet to the rack structure rails;
a front panel;
a hinge providing a normal position and an alternate position of said front panel, said hinge connecting said front panel to said cabinet such that said panel is located to the front side of said cabinet in the normal position, said hinge providing for repositioning of said front panel to the alternate position whereby access may be provided to the interior of said cabinet from the front side;
at least one screw insertable to restrain said front panel in the normal position;
and at least one set of battery mountings suitable for securing a battery enclosure to the interior of said cabinet, said battery mountings permitting the insertion and removal of a battery enclosure when said front panel is in an alternate position, said battery mountings including two opposing rails accepting slides formed in a battery enclosure, said battery mountings further including at least one stop preventing motion of a battery enclosure beyond a stop position.

20. A cabinet structure suitable for containing at least one battery, the cabinet structure providing access to at least one set of battery mountings from the front of the cabinet, the structure further mountable to a standard rack structure having rails for securing rack-mountable components, the cabinet structure comprising:
a cabinet having a front side;
means of mounting said cabinet to a rack structure;
a front panel;
means of connecting said cabinet to said front panel, said means of connecting providing a normal position in which said front panel is maintained in position to the front side of said cabinet, said means of connecting also providing at least one alternate position whereby access may be provided to the interior of said cabinet from the front side;
and means of mounting a battery enclosure, said means of mounting providing for insertion and removal of a battery enclosure when said means of connecting is in an alternate position state.
